(19) United States
(12) Patent Application Publication
(10) Pub. No.: US 2021/0152348 A1
(43) Pub. Date: May 20, 2021

(54) METHOD AND APPARATUS FOR PUBLIC-KEY CRYPTOGRAPHY BASED ON STRUCTURED MATRICES

(71) Applicant: INSTITUTE FOR BASIC SCIENCE, Daejeon (KR)

(72) Inventors: Kyung Ah SHIM, Daejeon (KR); Hyun Suk MOON, Daejeon (KR)

(21) Appl. No.: 16/845,601

(22) Filed: Apr. 10, 2020

(30) Foreign Application Priority Data
Nov. 19, 2019 (KR) 10-2019- 0149105

(51) Int. Cl. H04L 9/08; H04L 9/30; G06F 17/11

(52) U.S. Cl. CPC H04L 9/0861; G06F 17/11; H04L 9/30

(57) ABSTRACT

A method of generating a public key and a secret key using a key generator is disclosed. The method includes acquiring an affine map and a secret central map, and generating a public key and a secret key using the affine map and the secret central map, in which the secret central map is expressed as a system of o multivariate quadratic polynomials, the system of o multivariate quadratic polynomials can be expressed as a structured matrix or a product of a submatrix of a structured matrix and a vector when v linear equations and v variables defined on a finite field are given.

### CROSS-REFERENCE TO RELATED APPLICATION

This application claims priority under 35 U.S.C. § 119 from Korean Patent Application No. 10-2019-0149105 filed on Nov. 19, 2019, this disclosures of which are hereby incorporated by reference in their entireties.

### TECHNICAL FIELD

The present invention relates to public-key cryptography, and, in particular, to a method and an apparatus which can perform a digital signature algorithm based on multivariate quadratic polynomials based on structured matrices.

### DISCUSSION OF RELATED ART

Digital signature based on multivariate quadratic polynomials refers to digital signature (or referred to as “electronic signature”) used in a multivariate cryptography system. Here, a multivariate cryptography system refers to a system having asymmetric cryptographic primitives based on multivariate polynomials defined on a finite field. In particular, when a degree of multivariate polynomials used in the multivariate cryptography system is 2, the multivariate cryptography system is referred to as a cryptography system based on multivariate quadratic polynomials.

### SUMMARY

A technical object of the present invention is to provide a method, an apparatus, and a computer program, which can perform an electronic signature algorithm based on multivariate quadratic polynomials that can greatly reduce a length of a secret key by using structured matrices and quickly generate signatures by increasing efficiency in calculation.

According to embodiments of the present invention, a method of generating a public key and a secret key using a key generator includes acquiring an affine map \tilde{T} and a map [symbol] : [symbol] [symbol] ⁿ→ [symbol] _{q}^{m}, and generating a public key [symbol] = [symbol] ∘T and a secret key ( [symbol] , \tilde{T}) using the affine map and the map, in which the map [symbol] : [symbol] [symbol] ⁿ→ [symbol] _{q}^{m} is expressed as a system [symbol] _{V}⁽¹⁾, . . . , [symbol] _{V}^{(o)} of O multivariate quadratic polynomials, and the system [symbol] _{V}⁽¹⁾, . . . , [symbol] _{V}^{(o)} of O multivariate quadratic polynomials is expressed as below when υ linear equations L₁, . . . , L_{υ} and υ variables χ₁, . . . , χ_{υ} defined on a finite field [symbol] _{q} are given

$$( \begin{matrix}{ℱ}_{\text{?}}^{( \text{?} )} \\ {ℱ}_{\text{?}}^{( \text{?} )} \\ … \\ {ℱ}_{\text{?}}^{( \text{?} )}\end{matrix} ) = ( \begin{matrix}{x}_{\text{?}} {x}_{\text{?}} … {x}_{\text{?}} \\ … \\ … \\ …\end{matrix} ) \cdot ( \begin{matrix}{L}_{1} \\ {L}_{2} \\ … \\ {L}_{\text{?}}\end{matrix} ) = {M}_{\text{?}} \cdot ( \begin{matrix}{L}_{1} \\ {L}_{2} \\ … \\ {L}_{\text{?}}\end{matrix} ) , \\ \text{?} \text{indicates text missing or illegible when filed}$$

in which T: [symbol] _{q}ⁿ→ [symbol] _{q}ⁿ, \tilde{T}=T⁻¹, M_{V} is a structured matrix or a submatrix of a structured matrix, m=o, V={1, . . . , υ}, O={υ+1, . . . , υ+o}, |V|=υ, |O|=o, V is an index set for defining Vinegar variables, and O is an index set for defining Oil variables.

A computer program which is stored in a storage medium stores the method of generating a public key and a secret key using a key generator.

According to the embodiments of the present invention, an electronic signer includes the key generator configured to perform the method of generating a public key and a secret key, a signature generator configured to generate an electronic signature σ of a message M using the affine map \tilde{T}, the map [symbol] , and the message M, and a signature verifier configured to verify the electronic signature σ using the message M, the electronic signature σ, and the public key [symbol] = [symbol] ∘T, in which the signature generator calculates a hash message H(M)=ξ for the message M, calculates a solution s=(s₁, . . . , sₙ) of [symbol] (x)=ξ using [symbol] ⁻¹(ξ)=s when ξ=(ξ₁, . . . , ξₘ) is given, and calculates \tilde{T}(s)=σ, the signature verifier determines whether P(σ)=H(M) and verifies the electronic signature σ according to a result of the determination, H:{0, 1}*→ [symbol] _{q}^{m}, and H(M)=ξ=(ξ₁, . . . , ξₘ)∈ [symbol] _{q}^{m}.

According to the embodiments of the present invention, a method of generating a public key and a secret key using a key generator includes acquiring an affine map \tilde{T} and a map [symbol] : [symbol] [symbol] ⁿ→ [symbol] _{q}^{m}, and generating a public key [symbol] = [symbol] ∘T and a secret key ( [symbol] , \tilde{T}) using the affine map and the map, in which the map [symbol] : [symbol] [symbol] ⁿ→ [symbol] _{q}^{m} is expressed as a system [symbol] _{OV}⁽¹⁾, . . . , [symbol] _{OV}^{(o)} of O multivariate quadratic polynomials, and the system [symbol] _{OV}⁽¹⁾, . . . , [symbol] _{OV}^{(o)} of O multivariate quadratic polynomials is expressed as below when υ variables χ₁, . . . , χ_{υ} and O variables χ_{υ+1}, χ_{υ+2}, . . . , χ_{υ+o} defined on a finite field [symbol] _{q} are given

$$\begin{matrix}\begin{matrix}( \begin{matrix}{ℱ}_{OV}^{( 1 )} \\ {ℱ}_{OV}^{( 2 )} \\ ⋮ \\ {ℱ}_{OV}^{( )}\end{matrix} ) = ( \begin{matrix}{v}^{T} {a}_{11} & {v}^{T} {a}_{12} & … & {v}^{T} {a}_{\text{?} \text{?}} \\ {v}^{T} {a}_{21} & {v}^{T} {a}_{22} & … & {v}^{T} {a}_{\text{?} \text{?}} \\ ⋮ & ⋮ & ⋱ & ⋮ \\ {v}^{T} {a}_{\text{?} 1} & {v}^{T} {a}_{\text{?} 2} & … & {v}^{T} {a}_{\text{?} \text{?}}\end{matrix} ) ( \begin{matrix}{x}_{\text{?} + 1} \\ \text{?} \\ ⋮ \\ {x}_{\text{?} + \text{?}}\end{matrix} ) + \\ B ( \begin{matrix}{x}_{\text{?} + 1} \\ {x}_{\text{?} + 2} \\ ⋮ \\ {x}_{\text{?} + \text{?}}\end{matrix} ) \\ = ( \begin{matrix}{v}^{T} & 0 & … & 0 \\ 0 & {v}^{T} & … & 0 \\ ⋮ & ⋮ & ⋱ & ⋮ \\ 0 & 0 & … & {v}^{T}\end{matrix} ) ( \begin{matrix}{a}_{11} & {a}_{12} & … & {a}_{1 \text{?}} \\ {a}_{21} & {a}_{22} & … & {a}_{2 \text{?}} \\ ⋮ & ⋮ & ⋱ & ⋮ \\ {a}_{\text{?} 1} & {a}_{11} & … & {a}_{\text{?} \text{?}}\end{matrix} ) ( \begin{matrix}{x}_{\text{?} + 1} \\ \text{?} \\ ⋮ \\ {x}_{\text{?} + \text{?}}\end{matrix} ) + \\ B ( \begin{matrix}{x}_{\text{?} + 1} \\ {x}_{\text{?} + 2} \\ ⋮ \\ {x}_{\text{?} + \text{?}}\end{matrix} ) ,\end{matrix} & \\ \text{?} \text{indicates text missing or illegible when filed} & \end{matrix}$$

in which,

$$B = ( \begin{matrix}{b}_{11} & {b}_{12} & … & {b}_{1 \text{?}} \\ {b}_{21} & {b}_{22} & … & {b}_{2 \text{?}} \\ ⋮ & ⋮ & ⋱ & ⋮ \\ {b}_{\text{?} 1} & {b}_{\text{?} 2} & … & {b}_{\text{?} \text{?}}\end{matrix} ) , \\ {M}_{OV} = ( \begin{matrix}{a}_{11} & {a}_{12} & … & {a}_{1 \text{?}} \\ {a}_{21} & {a}_{22} & … & {a}_{2 \text{?}} \\ ⋮ & ⋮ & ⋱ & ⋮ \\ {a}_{\text{?} 1} & {a}_{\text{?} 2} & … & {a}_{\text{?} \text{?}}\end{matrix} ) , \\ \text{?} \text{indicates text missing or illegible when filed}$$

v^{T}=[χ₁ χ₂ . . . χ_{υ}], T: [symbol] _{q}ⁿ→ [symbol] _{q}ⁿ, \tilde{T}=T⁻¹, and, when each column vector aᵢⱼ is regarded as an element of one matrix, each column vector aᵢⱼ is selected such that M_{OV} is a structured matrix and element values of bᵢⱼ are selected such that B is also a structured matrix of the same form as M_{OV}.

A computer program that is stored in a storage medium stores the method of generating a public key and a secret key using a key generator.

According to the embodiments of the present invention, an electronic signer further includes the key generator configured to perform the method of generating a public key and a secret key, a signature generator configured to generate an electronic signature σ of a message M using the affine map \tilde{T}, the map [symbol] , and the message M, and a signature verifier configured to verify the electronic signature σ using the message M, the electronic signature σ, and the public key [symbol] = [symbol] ∘T, in which the signature generator calculates a hash messages H(M)=ξ for the message M, calculates a solution of s=(s₁, . . . , sₙ) of [symbol] (x)=ξ using [symbol] ⁻¹(ξ)=s when ξ=(ξ₁, . . . , ξₘ) is given, and calculates \tilde{T}(s)=σ, the signature verifier determines whether P(σ)=H(M) and verifies the electronic signature σ according to a result of the determination, H:{0, 1}*→ [symbol] _{q}^{m}, and H(M)=ξ=(ξ₁, . . . , ξₘ)∈ [symbol] _{q}^{m}.

According to the embodiments of the present invention, a method of generating a public key and a secret key using a key generator includes acquiring a first affine map \tilde{S}, a second affine map \tilde{T}, and a map [symbol] : [symbol] [symbol] ⁿ→ [symbol] _{q}^{m}, and generating a public key [symbol] =S∘ [symbol] ∘T and a secret key (\tilde{S}, [symbol] , \tilde{T}) using the first affine map, the second affine map, and the map, in which, when the map [symbol] : [symbol] [symbol] ⁿ→ [symbol] _{q}^{m} is expressed as a system [symbol] = [symbol] [symbol] , . . . , [symbol] ^{(m)} of multivariate quadratic polynomials having m=o₁+o₂ polynomials and n=υ+m variables, [symbol] ⁽ⁱ⁾ for i=1, . . . , o₁ is expressed as below

$$\{ \begin{matrix}{ℱ}^{( 1 )} ( \text{?} ) = {ℱ}_{V}^{( 1 )} ( \text{?} ) + {ℱ}_{OV}^{( 1 )} ( \text{?} ) + \text{?} \\ ⋮ \\ {ℱ}^{( {o}_{1} )} ( \text{?} ) = \text{?} + \text{?} ( \text{?} ) + \text{?}\end{matrix} , \\ \text{?} \text{indicates text missing or illegible when filed}$$

[symbol]

_{V}⁽ⁱ⁾ for i=1, . . . , o₁ is expressed as below when υ linear polynomials L₁, . . . , L_{υ} and υ variables χ₁, . . . , χ_{υ} defined on a finite field [symbol] _{q} are given

$$( \begin{matrix}{ℱ}_{V}^{( 1 )} \\ {ℱ}_{V}^{( 2 )} \\ ⋮ \\ {ℱ}_{V}^{( {o}_{1} )}\end{matrix} ) = ( \begin{matrix}{x}_{1} & {x}_{2} & ⋯ & {x}_{o} \\ ⋯ & ⋯ & ⋯ & ⋯ \\ ⋯ & ⋯ & ⋯ & ⋯ \\ ⋯ & ⋯ & ⋯ & ⋯\end{matrix} ) \cdot ( \begin{matrix}{L}_{1} \\ {L}_{2} \\ ⋯ \\ {L}_{v}\end{matrix} ) = {M}_{v} \cdot ( \begin{matrix}{L}_{1} \\ {L}_{2} \\ ⋯ \\ {L}_{v}\end{matrix} ) ,$$

in which M_{V}¹ is a structured matrix or a submatrix of a structured matrix, [symbol] ⁽ⁱ⁾ for i=o₁+1, . . . , m is expressed as below

$$\{ \begin{matrix}{ℱ}^{( {o}_{1} + 1 )} ( \text{?} ) = \text{?} ( \text{?} ) + \text{?} ( \text{?} ) + \text{?} \\ ⋮ \\ \text{?} ( \text{?} ) = \text{?} ( \text{?} ) + \text{?} + \text{?}\end{matrix} , \\ \text{?} \text{indicates text missing or illegible when filed}$$

and [symbol] _{V}⁽ⁱ⁾ for i=o₁+1, . . . , m is expressed as below when linear equations L′₁, . . . , L′_{υ+o}_{₁} with υ+o₁ variables and υ+o₁ variables are given

$$( \begin{matrix}{ℱ}_{V}^{( {o}_{1} + 1 )} \\ {ℱ}_{V}^{( {o}_{1} + 2 )} \\ ⋮ \\ \text{?}\end{matrix} ) = ( \begin{matrix}{x}_{1} & {x}_{2} & ⋯ & \text{?} \\ ⋯ & ⋯ & ⋯ & ⋯ \\ ⋯ & ⋯ & ⋯ & ⋯ \\ ⋯ & ⋯ & ⋯ & ⋯\end{matrix} ) \cdot ( \begin{matrix}{L}_{1}^{′} \\ {L}_{2}^{′} \\ ⋯ \\ \text{?}\end{matrix} ) = {M}_{V}^{2} \cdot ( \begin{matrix}{L}_{1}^{′} \\ {L}_{2}^{′} \\ ⋯ \\ \text{?}\end{matrix} ) , \\ \text{?} \text{indicates text missing or illegible when filed}$$

in which M_{V}² is a structured matrix or a submatrix of a structured matrix, m=o₁+o₂, S: [symbol] _{q}^{m}→ [symbol] _{q}^{m}, T: [symbol] _{q}ⁿ→ [symbol] _{q}ⁿ, \tilde{S}=S⁻¹, \tilde{T}=T⁻¹, V={1, . . . , υ}, O₁={υ+1, . . . , υ+o₁}, and O₂={υ+o₁+1, . . . , υ+o₁+o₂}, in which |V|=υ, |Oᵢ|=oᵢ for i=1 and 2, V is an index set for defining Vinegar variables, O₁ and O₂ are index sets for defining Oil variables.

According to the embodiments of the present invention, a method of generating a public key and a secret key using a key generator includes acquiring a first affine map (\tilde{S}) a second affine map (\tilde{T}), and a map ( [symbol] : [symbol] [symbol] ⁿ→ [symbol] _{q}^{m}), and generating a public key [symbol] =S∘ [symbol] ∘T and a secret key (\tilde{S}, [symbol] , \tilde{T}) using the first affine map, the second affine map, and the map, in which the map [symbol] : [symbol] [symbol] ⁿ→ [symbol] _{q}^{m} is expressed as a system [symbol] = [symbol] [symbol] , . . . , [symbol] ^{(m)} of m=o₁+o₂ multivariate quadratic polynomials, a system [symbol] _{OV}⁽¹⁾, . . . , [symbol] _{OV}^{(o}^{ⁱ}⁾ of the O₁ multivariate quadratic polynomials is expressed as below when υ variables (χ₁, . . . , χ_{υ}) and O₁ variables (χ_{υ+1}, χ_{υ+2}, . . . , χ_{υ+o}_{₁}) defined on a finite field [symbol] _{q} are given

$$( \begin{matrix}{ℱ}_{OV}^{( 1 )} \\ {ℱ}_{OV}^{( 2 )} \\ ⋮ \\ \text{?}\end{matrix} ) = ( \begin{matrix}{v}^{T} {a}_{11} & {v}^{T} {a}_{12} & ⋯ & \text{?} \\ {v}^{T} {a}_{21} & {v}^{T} {a}_{22} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + {B}_{1} ( \begin{matrix}\text{?} \\ \text{?} \\ ⋮ \\ \text{?}\end{matrix} ) = ( \begin{matrix}{v}^{T} & 0 & ⋯ & \text{?} \\ 0 & {v}^{T} & ⋯ & \text{?} \\ ⋮ & ⋮ & ⋱ & ⋮ \\ \text{?} & \text{?} & ⋯ & \text{?}\end{matrix} ) ( \begin{matrix}{a}_{11} & {a}_{12} & ⋯ & \text{?} \\ {a}_{21} & {a}_{22} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + {B}_{1} ( \begin{matrix}\text{?} \\ \text{?} \\ ⋮ \\ \text{?}\end{matrix} ) , \\ \text{?} \text{indicates text missing or illegible when filed}$$

in which,

$${M}_{OV , 1} = ( \begin{matrix}{a}_{11} & {a}_{12} & ⋯ & \text{?} \\ {a}_{21} & {a}_{22} & ⋯ & \text{?} \\ ⋮ & ⋮ & ⋱ & ⋮ \\ \text{?} & \text{?} & ⋯ & \text{?}\end{matrix} ) and {B}_{1} = ( \begin{matrix}{b}_{11} & {b}_{12} & ⋯ & \text{?} \\ {b}_{21} & {b}_{22} & ⋯ & \text{?} \\ ⋮ & ⋮ & ⋱ & ⋮ \\ \text{?} & \text{?} & ⋯ & \text{?}\end{matrix} )$$

$$\text{?} \text{indicates text missing or illegible when filed}$$

are given, v^{T}=[χ₁ χ₂ . . . χ_{υ}], each column vector aᵢⱼ is selected such that M_{OV,1} is a structured matrix and element values of bᵢⱼ are selected such that B₁ is also a structure matrix of the same form as M_{OV,1}, when each column vector aᵢⱼ is regarded as an element of one matrix, and [symbol] _{OV}⁽ⁱ⁾ for i=o₁+1, . . . , m is given as below

$$( \begin{matrix}\text{?} \\ \text{?} \\ ⋮ \\ \text{?}\end{matrix} ) = ( \begin{matrix}\text{?} & \text{?} & ⋯ & \text{?} \\ \text{?} & \text{?} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + {B}_{2} ( \begin{matrix}\text{?} \\ \text{?} \\ ⋮ \\ \text{?}\end{matrix} ) = ( \begin{matrix}{v}^{T} & 0 & ⋯ & \text{?} \\ 0 & {v}^{T} & ⋯ & \text{?} \\ ⋮ & ⋮ & ⋱ & ⋮ \\ \text{?} & \text{?} & ⋯ & \text{?}\end{matrix} ) ( \begin{matrix}{a}_{11}^{′} & {a}_{12}^{′} & ⋯ & \text{?} \\ \text{?} & \text{?} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + {B}_{2} ( \begin{matrix}\text{?} \\ \text{?} \\ ⋮ \\ \text{?}\end{matrix} ) , \\ \text{?} \text{indicates text missing or illegible when filed}$$

in which

$${M}_{OV , 2} = ( \begin{matrix}{a}_{11}^{′} & {a}_{12}^{′} & ⋯ & \text{?} \\ {a}_{21}^{′} & {a}_{22}^{′} & ⋯ & \text{?} \\ ⋮ & ⋮ & ⋱ & ⋮ \\ \text{?} & \text{?} & ⋯ & \text{?}\end{matrix} ) and {B}_{2} = ( \begin{matrix}{b}_{11}^{′} & {b}_{12}^{′} & ⋯ & \text{?} \\ {b}_{21}^{′} & {b}_{22}^{′} & ⋯ & \text{?} \\ ⋮ & ⋮ & ⋱ & ⋮ \\ \text{?} & \text{?} & ⋯ & \text{?}\end{matrix} )$$

$$\text{?} \text{indicates text missing or illegible when filed}$$

are given, v′^{T}=[χ₁ χ₂ . . . χ_{υ+o}_{₁}], each column vector a′ᵢⱼ is regarded as elements of one matrix, each column vector a′ᵢⱼ is selected such that M_{OV,2} is a structured matrix and element values of b′ᵢⱼ are selected such that B₂ is also a structured matrix of the same form as M_{OV,2} when each column vector a′ᵢⱼ is regarded as an element of one matrix,
S: [symbol] _{q}^{m}→ [symbol] _{q}^{m}, T: [symbol] _{q}ⁿ→ [symbol] _{q}ⁿ, \tilde{S}=S⁻¹, \tilde{T}=T⁻¹.

### BRIEF DESCRIPTION OF THE DRAWINGS

FIG. 1 is a block diagram of an electronic signer based on multivariate quadratic polynomials with one layer according to embodiments of the present invention;

FIG. 2 is a flowchart for describing an operation of the electronic signer based on multivariate quadratic polynomials shown in FIG. 1;

FIG. 3 is a block diagram of an electronic signer based on multivariate quadratic polynomials with two layers according to embodiments of the present invention; and

FIG. 4 is a flowchart for describing an operation of the electronic signer based on multivariate quadratic polynomials shown in FIG. 3.

### DETAILED DESCRIPTION OF EXEMPLARY EMBODIMENTS

In the present specification, an electronic signature algorithm (or an apparatus, a method, and/or a computer program stored in a storage medium capable of performing the electronic signature algorithm) based on a generation of systems of multivariate quadratic polynomials (or equations), which can be expressed by a product of a structured matrix (or a submatrix of the structured matrix) and a vector after performing a suitable operation or operations, is disclosed.

1. Generation of O (here, O is a natural number) quadratic polynomials which can be expressed by product of structured matrix or submatrix of structured matrix and vector using υ (Here, υ is a natural number) linear polynomials and υ variables (here, χᵢ, 1≤i≤υ).

When [symbol] _{q} is a finite field with q (here, q is a natural number) elements, and υ linear polynomials (L₁, . . . , L_{υ}) and υ variables (χ₁, . . . , χ_{υ}) defined on the finite field ( [symbol] _{q}) are given, a system ( [symbol] _{V}⁽¹⁾, . . . , [symbol] _{V}^{(o)}) of O quadratic polynomials, which can be expressed in a form of a product of a structured matrix (or a submatrix of a structured matrix) and a vector as shown in Equation 1 is generated.

The system ( [symbol] _{V}⁽¹⁾, . . . , [symbol] _{V}^{(o)}) of quadratic polynomials will be expressed by Equation 1, in which M_{V} is defined as a structured matrix (or a submatrix of a structured matrix).

$$( \begin{matrix}{ℱ}_{V}^{( 1 )} \\ {ℱ}_{V}^{( 2 )} \\ ⋮ \\ {ℱ}_{V}^{( o )}\end{matrix} ) = ( \begin{matrix}{x}_{1} & {x}_{2} & ⋯ & {x}_{o} \\ ⋯ & ⋯ & ⋯ & ⋯ \\ ⋯ & ⋯ & ⋯ & ⋯ \\ ⋯ & ⋯ & ⋯ & ⋯\end{matrix} ) \cdot ( \begin{matrix}{L}_{1} \\ {L}_{2} \\ ⋯ \\ {L}_{v}\end{matrix} ) = {M}_{v} \cdot ( \begin{matrix}{L}_{1} \\ {L}_{2} \\ ⋯ \\ {L}_{v}\end{matrix} ) \qquad [ Equation 1 ]$$

Here, the structure matrix includes a case in which complexity of the product of a structured matrix (or a submatrix of a structured matrix) and a vector is less than or equal to O(υ²).

### 1-1. Structured Matrix is Circulant Matrix

When υ linear polynomials (L₁, . . . , L_{υ}) and υ variables (χ₁, . . . , χ_{υ}) are given to an apparatus or a computer program, a system ( [symbol] _{V}⁽¹⁾, . . . , [symbol] _{V}^{(o)}) of O quadratic polynomials is generated as shown in Equation 2. Here, O is the number of quadratic polynomials, which is represented as O when there is one layer, and, when there are two layers, a first layer thereof is represented as O₁ and a second layer is represented as O₂.

$${ℱ}_{V}^{( 1 )} = {x}_{1} \cdot {L}_{1} + {x}_{2} \cdot {L}_{2} + … + \text{?} \cdot \text{?} \\ {ℱ}_{V}^{( 2 )} = \text{?} \cdot {L}_{1} + {x}_{1} \cdot {L}_{2} + … + \text{?} \cdot \text{?} \\ … , \\ {ℱ}_{V}^{( o )} = \text{?} \cdot {L}_{1} + \text{?} \cdot {L}_{2} + … + \text{?} \cdot \text{?} \\ \text{?} \text{indicates text missing or illegible when filed} \qquad [ Equation 2 ]$$

The system of quadratic polynomials in Equation 2 needs to be expressed in the form of a product of a circulant matrix (or a submatrix of a circulant matrix) and a vector as shown in Equation 3. That is, M_{V} in Equation 3 is a circulant matrix or a submatrix of a circulant matrix.

$$( \begin{matrix}{ℱ}_{V}^{( 1 )} \\ {ℱ}_{V}^{( 2 )} \\ ⋮ \\ \text{?}\end{matrix} ) = ( \begin{matrix}{x}_{1} & {x}_{2} & ⋯ & \text{?} \\ \text{?} & \text{?} & ⋯ & \text{?} \\ ⋯ & ⋯ & ⋯ & ⋯ \\ \text{?} & \text{?} & ⋯ & \text{?}\end{matrix} ) \cdot ( \begin{matrix}{L}_{1} \\ {L}_{2} \\ ⋯ \\ \text{?}\end{matrix} ) = {M}_{V} \cdot ( \begin{matrix}{L}_{1} \\ {L}_{2} \\ ⋯ \\ \text{?}\end{matrix} ) \\ \text{?} \text{indicates text missing or illegible when filed} \qquad [ Equation 3 ]$$

### 1-2. Additional Generation of System of Quadratic Equations Expressed by Block Circulant Matrix

After quadratic polynomials for variables (χ₁, . . . , X_{υ}) are selected as described in 1-1, a system ( [symbol] _{OV}⁽¹⁾, . . . , [symbol] _{OV}^{(o)}) of quadratic polynomials for o(=2k) (Here, k is a natural number) variables (χ_{υ+1}, χ_{υ+2}, . . . , χ_{υ+o}) is additionally generated as shown in Equation 4.

$$( \begin{matrix}{ℱ}_{OV}^{( 1 )} \\ {ℱ}_{OV}^{( 2 )} \\ ⋮ \\ \text{?}\end{matrix} ) = ( \begin{matrix}{v}^{T} {a}_{11} & {v}^{T} {a}_{12} & ⋯ & \text{?} \\ {v}^{T} {a}_{21} & {v}^{T} {a}_{22} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + B ( \begin{matrix}\text{?} \\ \text{?} \\ ⋮ \\ \text{?}\end{matrix} ) = ( \begin{matrix}{v}^{T} & 0 & ⋯ & \text{?} \\ 0 & {v}^{T} & ⋯ & \text{?} \\ ⋮ & ⋮ & ⋱ & ⋮ \\ \text{?} & \text{?} & ⋯ & \text{?}\end{matrix} ) ( \begin{matrix}{a}_{11} & {a}_{12} & ⋯ & \text{?} \\ {a}_{21} & {a}_{22} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + B ( \begin{matrix}\text{?} \\ \text{?} \\ ⋮ \\ \text{?}\end{matrix} ) \\ {M}_{OV} = ( \begin{matrix}{a}_{11} & {a}_{12} & ⋯ & \text{?} \\ {a}_{21} & {a}_{22} & ⋯ & \text{?} \\ ⋮ & ⋮ & ⋱ & ⋮ \\ \text{?} & \text{?} & ⋯ & \text{?}\end{matrix} ) = ( \begin{matrix}\text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?}\end{matrix} ) = ( \begin{matrix}P & \text{?} \\ \text{?} & S\end{matrix} ) \\ B = ( \begin{matrix}{b}_{11} & {b}_{12} & ⋯ & \text{?} \\ {b}_{21} & {b}_{22} & ⋯ & \text{?} \\ ⋮ & ⋮ & ⋱ & ⋮ \\ \text{?} & \text{?} & ⋯ & \text{?}\end{matrix} ) = ( \begin{matrix}\text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?}\end{matrix} ) \\ \text{?} \text{indicates text missing or illegible when filed} \qquad [ Equation 4 ]$$

Here v^{T}=[χ₁ χ₂ . . . χ_{υ}], each of P, Q, R, S is a circulant matrix of vectors, M_{OV} is a block circulant matrix of the vectors, and B is also a block circulant matrix with the same structure as M_{OV}.

A system of quadratic equations such as in Equation 5 without quadratic terms that satisfy χᵢχⱼ, i, j=υ+1, .. . , υ+o (here, each of i and j is a natural number) is generated by combining the system of quadratic polynomials in Equation 4 and the system of quadratic polynomials in Equation 2. Here, δᵢ is a constant term selected in the finite field ( [symbol] _{q}).

$$\{ \begin{matrix}{ℱ}^{( 1 )} ( \text{?} ) = {ℱ}_{V}^{( 1 )} ( \text{?} ) + {ℱ}_{OV}^{( 1 )} ( \text{?} ) + \text{?} \\ ⋮ \\ {ℱ}^{( o )} ( \text{?} ) = {ℱ}_{V}^{( o )} ( \text{?} ) \text{?} + {ℱ}_{OV}^{( o )} ( \text{?} ) + \text{?}\end{matrix} \\ \text{?} \text{indicates text missing or illegible when filed} \qquad [ Equation 5 ]$$

### 2. Generation of System of Quadratic Equations in Which Coefficient Matrix Has Structured Matrix Structure

In a system of quadratic polynomials having n=υ+o (n is a natural number) variables which can be expressed as shown in equation 6, it is assumed that there is a system ( [symbol] _{OV}⁽ⁱ⁾) of quadratic polynomials for υ variables (χ₁, . . . , χ_{υ}) and O variables (χ_{υ+1}, χ_{υ+2}, . . . , χ_{υ+o}).

$$( \begin{matrix}{ℱ}_{OV}^{( 1 )} \\ {ℱ}_{OV}^{( 2 )} \\ ⋮ \\ \text{?}\end{matrix} ) = ( \begin{matrix}{v}^{T} {a}_{11} & {v}^{T} {a}_{12} & ⋯ & \text{?} \\ {v}^{T} {a}_{21} & {v}^{T} {a}_{22} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + B ( \begin{matrix}\text{?} \\ \text{?} \\ ⋮ \\ \text{?}\end{matrix} ) = ( \begin{matrix}{v}^{T} & 0 & ⋯ & \text{?} \\ 0 & {v}^{T} & ⋯ & \text{?} \\ ⋮ & ⋮ & ⋱ & ⋮ \\ \text{?} & \text{?} & ⋯ & \text{?}\end{matrix} ) ( \begin{matrix}{a}_{11} & {a}_{12} & ⋯ & \text{?} \\ {a}_{21} & {a}_{22} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + B ( \begin{matrix}\text{?} \\ \text{?} \\ ⋮ \\ \text{?}\end{matrix} ) \\ \text{?} \text{indicates text missing or illegible when filed} \qquad [ Equation 6 ]$$

Here, v^{T}=[χ₁ χ₂ . . . χ_{υ}], and B and M_{OV} are expressed as shown in Equation 7.

$$B = ( \begin{matrix}{b}_{11} & {b}_{12} & ⋯ & \text{?} \\ {b}_{21} & {b}_{22} & ⋯ & \text{?} \\ ⋮ & ⋮ & ⋱ & ⋮ \\ \text{?} & \text{?} & ⋯ & \text{?}\end{matrix} ) , {M}_{OV} = ( \begin{matrix}{a}_{11} & {a}_{12} & ⋯ & \text{?} \\ {a}_{21} & {a}_{22} & ⋯ & \text{?} \\ ⋮ & ⋮ & ⋱ & ⋮ \\ \text{?} & \text{?} & ⋯ & \text{?}\end{matrix} ) \\ \text{?} \text{indicates text missing or illegible when filed} \qquad [ Equation 7 ]$$

Here, when each column vector aᵢⱼ is regarded as an element of one matrix, each column vector aᵢⱼ is selected such that M_{OV} is a structured matrix, element values of bᵢⱼ are selected such that B is a structure matrix of the same form as M_{OV}, thereby a system of desired quadratic polynomials is generated.

Here, the structured matrix includes a case in which complexity of obtaining an existing structured matrix or inverse matrix, or finding a solution of a system of a linear equation having a structured matrix as a coefficient matrix is less than or equal to O(n²). At this time, a size of the coefficient matrix of the system of a linear equation is n×n.

### 2-1. M_{OV} and B Are Block Circulant Matrices (BC).

When (o=2k) is an even number, M_{OV} and B are selected such that M_{OV} and B are block circulant matrices, respectively, as shown in Equations 8 and 9.

$${M}_{OV} = ( \begin{matrix}{a}_{11} & {a}_{12} & ⋯ & {a}_{\text{?}} \\ {a}_{21} & {a}_{22} & ⋯ & {a}_{\text{?}} \\ ⋮ & ⋮ & ⋱ & ⋮ \\ {a}_{o 1} & {a}_{o 2} & ⋯ & {a}_{\text{?}}\end{matrix} ) = ( \begin{matrix}{p}_{1} & {p}_{2} & ⋯ & {p}_{k} & {q}_{1} & {q}_{2} & ⋯ & {q}_{k} \\ {p}_{k} & {p}_{1} & ⋯ & {p}_{k - 1} & {q}_{k} & {q}_{1} & ⋯ & {q}_{k - 1} \\ ⋮ & ⋮ & ⋱ & ⋮ & ⋮ & ⋮ & ⋱ & ⋮ \\ {p}_{2} & {p}_{3} & ⋯ & {p}_{1} & {q}_{2} & {q}_{3} & ⋯ & {q}_{1} \\ {r}_{1} & {r}_{2} & ⋯ & {r}_{k} & {s}_{1} & {s}_{2} & ⋯ & {s}_{k} \\ {r}_{k} & {r}_{1} & ⋯ & {r}_{k - 1} & {s}_{k} & {s}_{1} & ⋯ & {s}_{k - 1} \\ ⋮ & ⋮ & ⋱ & ⋮ & ⋮ & ⋮ & ⋱ & ⋮ \\ {r}_{2} & {r}_{3} & ⋯ & {r}_{1} & {s}_{2} & {s}_{3} & ⋯ & {s}_{1}\end{matrix} ) = ( \begin{matrix}P & Q \\ R & S\end{matrix} ) \\ \text{?} \text{indicates text missing or illegible when filed} \qquad [ Equation 8 ]$$

Here, each of P, Q, R, S is a circulant matrix of vectors, and M_{OV} is a block circulant matrix of the vectors.

$$B = ( \begin{matrix}{b}_{11} & {b}_{12} & ⋯ & {b}_{} \\ {b}_{21} & {b}_{22} & ⋯ & {b}_{} \\ ⋮ & ⋮ & ⋱ & ⋮ \\ {b}_{o 1} & {b}_{o 2} & ⋯ & {b}_{oo}\end{matrix} ) = ( \begin{matrix}{t}_{1} & {t}_{2} & ⋯ & {t}_{k} & {u}_{1} & {u}_{2} & ⋯ & {u}_{k} \\ {t}_{k} & {t}_{1} & ⋯ & {t}_{k - 1} & {u}_{k} & {u}_{1} & ⋯ & {u}_{k - 1} \\ ⋮ & ⋮ & ⋱ & ⋮ & ⋮ & ⋮ & ⋱ & ⋮ \\ {t}_{2} & {t}_{3} & ⋯ & {t}_{1} & {u}_{2} & {u}_{3} & ⋯ & {u}_{1} \\ {v}_{1} & {v}_{2} & ⋯ & {v}_{k} & {w}_{1} & {w}_{2} & ⋯ & {w}_{k} \\ {v}_{k} & {v}_{1} & ⋯ & {v}_{k - 1} & {w}_{k} & {w}_{1} & ⋯ & {w}_{k - 1} \\ ⋮ & ⋮ & ⋱ & ⋮ & ⋮ & ⋮ & ⋱ & ⋮ \\ {v}_{2} & {v}_{3} & ⋯ & {v}_{1} & {w}_{2} & {w}_{3} & ⋯ & {w}_{1}\end{matrix} ) \qquad [ Equation 9 ]$$

Here, B is a block circulant matrix.

### 2-2. Method of Efficiently Calculating Inverse Matrix (BC⁻¹) of Given Block Circulant Matrix (BC)

A block determinant (K−PS−QR) of a given block circulant matrix

$$( BC = ( \begin{matrix}P & Q \\ R & S\end{matrix} ) )$$

is obtained. Since all of P, Q, R, S are circulant matrices, K is also a circulant matrix.

First, an inverse matrix (K⁻¹) of K is obtained, and an inverse matrix (BC⁻¹) of BC is obtained by calculating

$$( \begin{matrix}{K}^{- 1} S & - {K}^{- 1} Q \\ - {K}^{- 1} R & {K}^{- 1} P\end{matrix} ) .$$

At this time, efficient algorithms such as the Extended Euclidean Algorithm are used to obtain the inverse matrix of K.

### 3. Randomization Using Structured Matrix

Embodiments of message randomization or secret key randomization to cope with various types of attacks such as a side-channel attack are as below.
(i) generating a first operation result by adding a matrix and a message (or a secret key), and then, subtracting the matrix from the first operation result, or
(ii) generate a second operation result by multiplying a matrix and a message (or a secret key), and then, multiplying the second operation result by an inverse matrix of the matrix.

At this time, if the matrix is selected as a structured matrix, calculation efficiency can be increased.

### 3-1. Randomization Using a Circulant Matrix or a Block Circulant Matrix

Embodiments of message randomization or secret key randomization to cope with various types of attacks such as a side-channel attack are as below.
(i) generating a first operation result by adding a matrix and a message (or a secret key), and then, subtracting the matrix from the first operation result, or
(ii) generating a second operation result by multiplying a matrix and a message (or a secret key), and then, multiplying the second operation result by an inverse matrix of the matrix.

At this time, if a random matrix is selected as a circulant matrix or a block circulant matrix, the calculation efficiency can be increased.

3-2. When [symbol] _{q} is a finite field with q elements, if a random matrix (R) is selected as a circulant matrix as shown in Equation 10 to randomize a secret key (\tilde{S}) in a product (\tilde{S}·h) of a vector (h) of [symbol] _{q}^{m} and the secret key (\tilde{S}), the calculation efficiency can be increased.

\tilde{S}(H(M))=(\tilde{S}+R)(H(M))(−R(H(M))

or

\tilde{S}(H(M))=(\tilde{S}·R⁻¹·R)(H(M)) [Equation 10]

Here, \tilde{S}=S⁻¹, and H(M) is a hash value for a message M and is expressed as H(M)=ξ=(ξ₁, . . . , ξₘ)∈ [symbol] _{q}^{m}.

The electronic (or digital) signature algorithms based on multivariate quadratic polynomials (or equations) according to the present invention include a key generation algorithm, a signature generation algorithm, and a signature verification algorithm. The electronic signature algorithms based on multivariate quadratic polynomials are executed by an electronic apparatus (or a digital signature apparatus) or a computer program being executed in the electronic apparatus.

A computer program stored in a storage medium has a program code for performing a method for electronic signature algorithms based on a structured matrix (algorithms that protect authentication, non-repudiation, and/or integrity of a message (or data)), and the program code is executed in a computing apparatus.

The computing apparatus refers to a PC (personal computer), a server, or a mobile device, and the mobile device refers to a mobile phone, a smartphone, an Internet mobile device (MID), a laptop computer, or the like, but the present invention is not limited thereto.

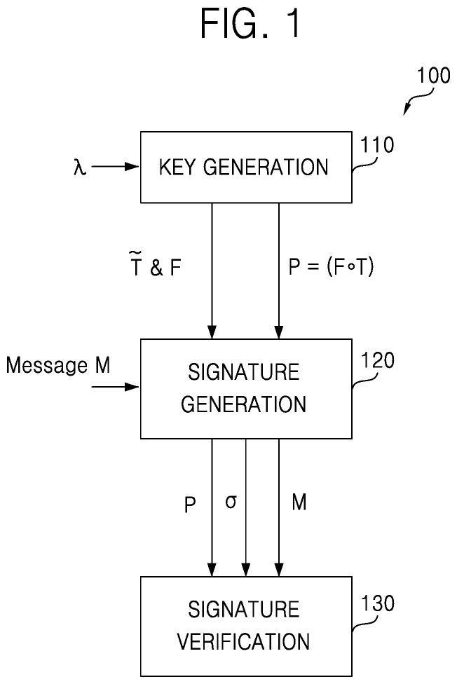

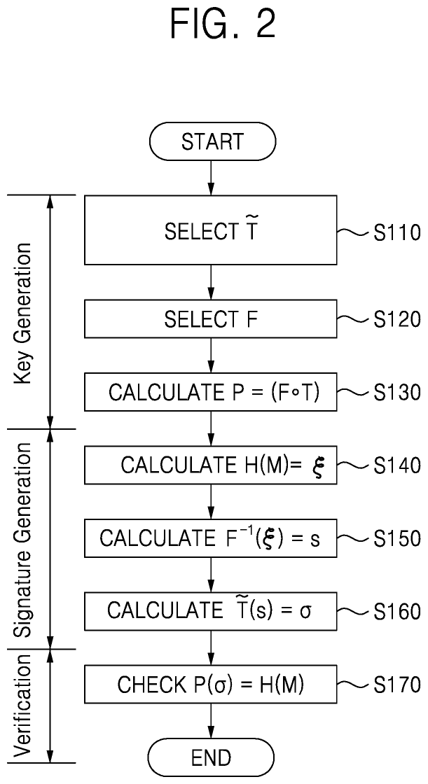

FIG. 1 is a block diagram of an electronic signer based on multivariate quadratic polynomials with one layer according to embodiments of the present invention, and FIG. 2 is a flowchart for describing an operation of the electronic signer based on multivariate quadratic polynomials shown in FIG. 1. An electronic signer 100 of FIG. 1 constitutes a secret central map having one layer, executes electronic signature algorithms based on multivariate quadratic polynomials using the secret central map, and includes a key generator 110, a signature generator 120, and a signature verifier 130.

In the present specification, the electronic signer 100 or 200 may be implemented as a hardware component or a software component. When the electronic signer 100 or 200 is implemented as a hardware component, each of the components 110, 120, and 130 is implemented as a hardware component, and, when the electronic signer 100 is implemented as a software component, each of the components 110, 120, and 130 is implemented as a software component.

### Key Generation Algorithm

The key generator 110 performs steps (S110 to S130) to perform the key generation algorithm for calculating a public key.

For a security parameter (λ), a pair (<PK, SK>=< [symbol] , ( [symbol] , \tilde{T})>) of a public key (PK) and a secret key (SK) is generated as follows. The security parameter (λ) indicates a security level.
1. one affine map (\tilde{T}) is randomly selected (S110). If the affine map (\tilde{T}) is not invertible, a new affine map will be randomly selected again. Here, T: [symbol] _{q}ⁿ→ [symbol] _{q}ⁿ and, \tilde{T}=T⁻¹. It is assumed that affine maps and a secret central map ( [symbol] = [symbol] [symbol] , . . . , [symbol] ^{(m)}) are securely stored in an apparatus (for example, a data storage apparatus) which can be accessed by the key generator 110.
2. The secret central map ( [symbol] = [symbol] [symbol] , . . . , [symbol] ^{(m)}) is selected as below (S120).

For application to electronic signature algorithms based on multivariate quadratic polynomials using a structured matrix, a configuration of a new central map according to the present invention requires two index sets (V, O) when there is one (1) layer. [symbol] : [symbol] [symbol] ⁿ→ [symbol] _{q}^{m}, and each of n and m is a natural number.

V={1, . . . , υ}

O={υ+1, . . . , υ+o}

Here, |V|=υ, and |O|=o. V is an index set for defining Vinegar variables, and O is an index set for defining Oil variables.

In the secret central map ( [symbol] = [symbol] [symbol] , . . . , [symbol] ^{(m)}), that is, a system of multivariate quadratic polynomials having m=o equations and n=υ+m variables, [symbol] ⁽ⁱ⁾ for i=1, . . . , o will be defined as shown in Equation 11.

$$[ Equation 11 ]$$

$$\{ \begin{matrix}{ℱ}^{( 1 )} ( {x}_{1} , ⋯ , {x}_{v + o} ) = {ℱ}_{V}^{( 1 )} ( {x}_{i} , ⋯ , {x}_{v} ) + {ℱ}_{OV}^{( 1 )} ( {x}_{1} , ⋯ , {x}_{v + o} ) + {δ}_{1} \\ ⋮ \\ {ℱ}^{( o )} ( {x}_{1} , ⋯ , {x}_{v + o} ) = {ℱ}_{V}^{( o )} ( {x}_{i} , ⋯ , {x}_{v} ) + {ℱ}_{OV}^{( o )} ( {x}_{1} , ⋯ , {x}_{v + o} ) + {δ}_{o}\end{matrix}$$

[symbol] _{V}⁽ⁱ⁾ for i=1, . . . , o will be defined as shown in Equation 12,

$$( \begin{matrix}{ℱ}_{OV}^{( 1 )} \\ {ℱ}_{OV}^{( 2 )} \\ ⋮ \\ {F}_{OV}^{( o )}\end{matrix} ) = ( \begin{matrix}{x}_{1} & {x}_{2} & ⋯ & {x}_{v} \\ {x}_{\text{?}} & {x}_{1} & ⋯ & {x}_{v - 1} \\ ⋮ & ⋮ & ⋱ & ⋮ \\ {x}_{\text{?} + 2} & {x}_{\text{?} + 3} & ⋯ & {x}_{\text{?} 1}\end{matrix} ) \cdot ( \begin{matrix}{L}_{1} \\ {L}_{2} \\ ⋯ \\ {L}_{\text{?}}\end{matrix} ) + {M}_{v} \cdot ( \begin{matrix}{L}_{1} \\ {L}_{2} \\ ⋯ \\ {L}_{\text{?}}\end{matrix} ) \\ \text{?} \text{indicates text missing or illegible when filed} \qquad [ Equation 12 ]$$

Here, Mᵥ is a circulant matrix or a submatrix of a circulant matrix.

[symbol] _{OV}⁽ⁱ⁾ for i=1, . . . , o will be defined as shown in Equation 13, and

$$( \begin{matrix}{ℱ}_{OV}^{( 1 )} \\ {ℱ}_{OV}^{( 2 )} \\ ⋮ \\ {F}_{OV}^{( o )}\end{matrix} ) = ( \begin{matrix}{v}^{T} {a}_{11} & {v}^{T} {a}_{12} & ⋯ & {v}^{T} {a}_{1 o} \\ {v}^{T} {a}_{21} & {v}^{T} {a}_{22} & ⋯ & {v}^{T} {a}_{2 o} \\ ⋮ & ⋮ & ⋱ & ⋮ \\ {v}^{T} {a}_{o 1} & {v}^{T} {a}_{o 2} & ⋯ & {v}^{T} {a}_{o o}\end{matrix} ) ( \begin{matrix}{x}_{v + 1} \\ {x}_{v + 2} \\ ⋮ \\ {x}_{v + o}\end{matrix} ) + B ( \begin{matrix}{x}_{v + 1} \\ {x}_{v + 2} \\ ⋮ \\ {x}_{v + o}\end{matrix} ) = ( \begin{matrix}{v}^{T} & 0 & ⋯ & 0 \\ 0 & {v}^{T} & ⋯ & 0 \\ ⋮ & ⋮ & ⋱ & ⋮ \\ 0 & 0 & ⋯ & {v}^{T}\end{matrix} ) ( \begin{matrix}{a}_{11} & {a}_{12} & ⋯ & {a}_{1 o} \\ {a}_{21} & {a}_{22} & ⋯ & {a}_{2 o} \\ ⋮ & ⋮ & ⋱ & ⋮ \\ {a}_{o 1} & {a}_{o 2} & ⋯ & {a}_{oo}\end{matrix} ) ( \begin{matrix}{x}_{v + 1} \\ {x}_{v + 2} \\ ⋮ \\ {x}_{v + o}\end{matrix} ) + B ( \begin{matrix}{x}_{v + 1} \\ {x}_{v + 2} \\ ⋮ \\ {x}_{v + o}\end{matrix} ) \qquad [ Equation 13 ]$$

Here, B is the same as B in Equation 9, and M_{OV} is the same as M_{OV} in Equation 8.

$$B = ( \begin{matrix}{b}_{11} & {b}_{12} & ⋯ & {b}_{1 o} \\ {b}_{21} & {b}_{22} & ⋯ & {b}_{2 o} \\ ⋮ & ⋮ & ⋱ & ⋮ \\ {b}_{o 1} & {b}_{o 2} & ⋯ & {b}_{oo}\end{matrix} ) , {M}_{OV} = ( \begin{matrix}{a}_{11} & {a}_{12} & ⋯ & {a}_{1 o} \\ {a}_{21} & {a}_{22} & ⋯ & {a}_{2 o} \\ ⋮ & ⋮ & ⋱ & ⋮ \\ {a}_{o 1} & {a}_{o 2} & ⋯ & {a}_{\text{?}}\end{matrix} ) , {M}_{OV} = ( \begin{matrix}{a}_{11} & {a}_{12} & ⋯ & {a}_{1 o} \\ {a}_{21} & {a}_{22} & ⋯ & {a}_{2 o} \\ ⋮ & ⋮ & ⋱ & ⋮ \\ {a}_{o 1} & {a}_{o 2} & ⋯ & {a}_{\text{?}}\end{matrix} ) = ( \begin{matrix}{p}_{1} & {p}_{2} & ⋯ & {p}_{k} & {q}_{1} & {q}_{2} & ⋯ & {q}_{k} \\ {p}_{k} & {p}_{1} & ⋯ & {p}_{k - 1} & {q}_{k} & {q}_{1} & ⋯ & {q}_{k - 1} \\ ⋮ & ⋮ & ⋱ & ⋮ & ⋮ & ⋮ & ⋱ & ⋮ \\ {p}_{2} & {p}_{3} & ⋯ & {p}_{1} & {q}_{2} & {q}_{3} & ⋯ & {q}_{1} \\ {r}_{1} & {r}_{2} & ⋯ & {r}_{k} & {s}_{1} & {s}_{2} & ⋯ & {s}_{k} \\ {r}_{k} & {r}_{1} & ⋯ & {r}_{k - 1} & {s}_{k} & {s}_{1} & ⋯ & {s}_{k - 1} \\ ⋮ & ⋮ & ⋱ & ⋮ & ⋮ & ⋮ & ⋱ & ⋮ \\ {r}_{2} & {r}_{3} & ⋯ & {r}_{1} & {s}_{2} & {s}_{3} & ⋯ & {s}_{1}\end{matrix} ) = ( \begin{matrix}P & Q \\ R & S\end{matrix} )$$

$$B = ( \begin{matrix}{b}_{11} & {b}_{12} & ⋯ & {b}_{\text{?}} \\ {b}_{21} & {b}_{22} & ⋯ & {b}_{\text{?}} \\ ⋮ & ⋮ & ⋱ & ⋮ \\ {b}_{o 1} & {b}_{o 2} & ⋯ & {b}_{oo}\end{matrix} ) = ( \begin{matrix}{t}_{1} & {t}_{2} & ⋯ & {t}_{k} & {u}_{1} & {u}_{2} & ⋯ & {u}_{k} \\ {t}_{k} & {t}_{1} & ⋯ & {t}_{k - 1} & {u}_{k} & {u}_{1} & ⋯ & {u}_{k - 1} \\ ⋮ & ⋮ & ⋱ & ⋮ & ⋮ & ⋮ & ⋱ & ⋮ \\ {t}_{2} & {t}_{3} & ⋯ & {t}_{1} & {u}_{2} & {u}_{3} & ⋯ & {u}_{1} \\ {v}_{1} & {v}_{2} & ⋯ & {v}_{k} & {w}_{1} & {w}_{2} & ⋯ & {w}_{k} \\ {v}_{k} & {v}_{1} & ⋯ & {v}_{k - 1} & {w}_{k} & {w}_{1} & ⋯ & {w}_{k - 1} \\ ⋮ & ⋮ & ⋱ & ⋮ & ⋮ & ⋮ & ⋱ & ⋮ \\ {v}_{2} & {v}_{3} & ⋯ & {v}_{1} & {w}_{2} & {w}_{3} & ⋯ & {w}_{1}\end{matrix} )$$

$$\text{?} \text{indicates text missing or illegible when filed}$$

A constant term (δᵢ) is randomly selected in the finite field ( [symbol] _{q}).
3. A public key ( [symbol] = [symbol] ∘T) is calculated (S130). Here, a circle means a composition, the public key ( [symbol] = [symbol] ∘T) is required for signature verification, and a secret key (SK=( [symbol] , \tilde{T}) is required for signature generation.

### Signature Generation Algorithm

A signature generator 120 performs steps (S140 to S160) to perform the signature generation algorithm, that is, how to invert a new central map according to the present invention.

The signature generator 120 receives an affine map \tilde{T}, a secret central map [symbol] , and a message M. The message M refers to a message to be transmitted via a communication medium (for example, wired or wireless) as plain text.
1. A hash message (H(M)=ξ) for the message M is calculated (S140). Here,
   H:{0, 1}*→ [symbol] _{q}^{m} is a collision resistant hash function.
   H(M)=ξ=(ξ₁, . . . , ξₘ)∈ [symbol] _{q}^{m} is calculated.
2. When ο=(ξ₁, . . . , ξₘ) is given, processes of finding [symbol] ⁻¹(ξ)=s, that is, a solution s=(s₁, . . . , sₙ) of [symbol] (x)=ξ are as below (S150).

A vector of random values sᵥ=(s₁, . . . , s_{υ})∈ [symbol] _{q}^{υ} is selected. The vector (sᵥ) is plugged into [symbol] _{V}⁽ⁱ⁾ for i=1, . . . , m to calculate a product of a o×υ submatrix of a υ×υ circulant matrix and a transpose of a vector ((L₁(s_{υ}), . . . , L_{υ}(s_{υ}))), and, as a result, (c₁, . . . , cₒ) is obtained. At this time, the o×υ submatrix is M_{V} in Equation 3.

If the vector (sᵥ) is plugged into [symbol] _{OV}⁽ⁱ⁾ for i=1, . . . , m to obtain a system of O linear equations having O variables (χ_{υ+1}, . . . , χₙ), a form of the coefficient matrix is a block circulant matrix (BC).

Here, the block circulant matrix (BC) is a matrix obtained by multiplying a matrix that is obtained by plugging the vector (sᵥ) into a matrix composed of v^{T} in Equation 13 by M_{OV}.

A solution (s_{υ+1}, . . . , sₙ), is obtained by multiplying the inverse matrix (BC⁻¹) obtained by the method defined in 2-2 described above by a transpose of (ξ₁−c₁−δ₁, . . . , ξₒ−cₒ−δₒ). Accordingly, a vector s=(s₁, . . . , sₙ) is a solution of [symbol] (x)=ξ.

If there is no inverse matrix BC⁻¹ of the block circulant matrix BC, the procedure returns to a beginning of the signature generation algorithm to select a vector of new random values sᵥ′=(s′₁, . . . , s′_{υ}) and performs the methods (or processes) described above again.
3. \tilde{T}(s)=σ is calculated (S160). σ refers to a signature of the message M (here, the signature means a digital signature or an electronic signature).

### Signature Verification or Verification Algorithm

The signature verifier 130 performs a step (S170) to perform a signature verification or verification algorithm. If the signature verifier 130 receives one of the public key [symbol] and a certificate including the public key [symbol] , the message M, and the signature σ from the signature generator 120, that is, if the public key [symbol] and the signature σ for the message M are given, the signature verifier 130 checks whether P(σ)=H(M). If P(σ)=H(M), the signature σ is accepted, and otherwise, the signature σ is rejected.

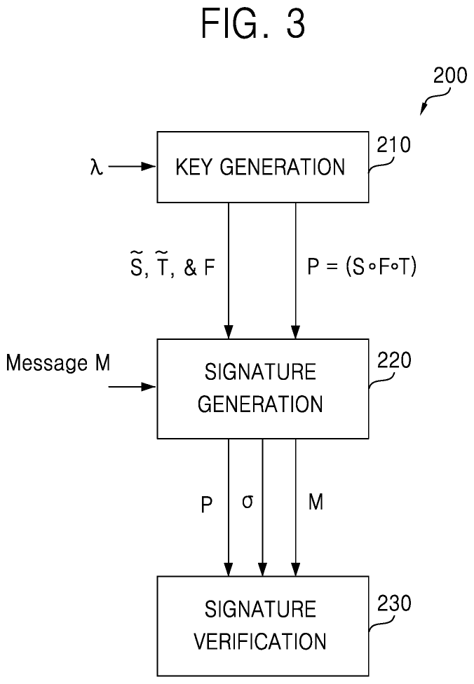

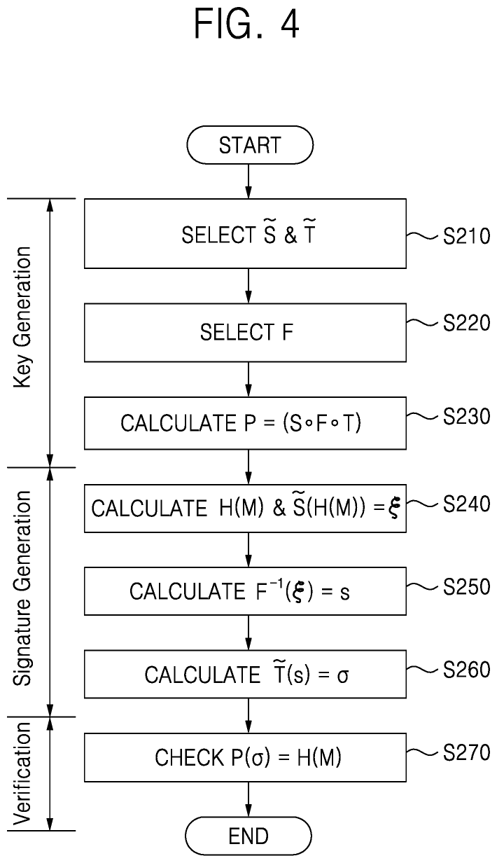

FIG. 3 is a block diagram of an electronic signer based on multivariate quadratic polynomials with two layers according to embodiments of the present invention. FIG. 4 is a flowchart for describing an operation of the electronic signer based on multivariate quadratic polynomials shown in FIG. 3. The electronic signer 200 of FIG. 3 constitutes and processes a secret central map with two layers.

The key generator 210 performs step (S210) to perform the key generation algorithm for calculating a secret key and a public key.

### Key Generation Algorithm:

For the security parameter (λ), a pair (<PK, SK>=< [symbol] , (\tilde{S}, [symbol] , \tilde{T})>) of a public key (PK) and a secret (SK) is generated as follows. The security parameter (λ) represents a security level.
1. Two affine maps \tilde{S} and \tilde{T} are randomly selected (S210). If \tilde{S} and \tilde{T} are not invertible, two (new) affine maps \tilde{S} and \tilde{T} are randomly selected again. Here, S: [symbol] _{q}^{m}→ [symbol] _{q}^{m} and \tilde{S}=S⁻¹, and T: [symbol] _{q}ⁿ→ [symbol] _{q}ⁿ and, \tilde{T}=T⁻¹. Affine maps including the affine maps \tilde{S} and \tilde{T} and the secret central map ( [symbol] = [symbol] [symbol] , . . . , [symbol] ^{(m)} can be securely stored in an apparatus which can be accessed by the key generator 210.
2. The secret central map [symbol] = [symbol] [symbol] , . . . , [symbol] ^{(m)} is selected as below (S220).

For application to electronic signature algorithms based on multivariate quadratic polynomials using a structured matrix, a configuration of a new central map according to the present invention requires two index sets (V, O₁, and O₂) when there are two layers.

V={1, . . . , υ},

O₁={υ+1, . . . , υ+o₁},

O₂={υ+o₁+1, . . . , υ+o₁+o₂}

Here, |V|=υ, and |Oᵢ|=oᵢ for i=1, 2. V is an index set for defining Vinegar variables, and O₁ and O₂ are index sets for defining Oil variables.

In the secret central map [symbol] = [symbol] [symbol] , . . . , [symbol] ^{(m)}, that is, a system of quadratic polynomials having m=o₁+o₂ (here, each of O₁ and O₂ and is a natural number) polynomials and n=υ+m variables, [symbol] ⁽ⁱ⁾ for i=1, . . . , o₁ will be defined as shown in Equation 14.

$$\{ \begin{matrix}{ℱ}^{( 1 )} ( {x}_{1} , ⋯ , {x}_{v + o} ) = {ℱ}_{v}^{( 1 )} ( {x}_{i} , ⋯ , {x}_{v} ) + {ℱ}_{OV}^{( 1 )} ( {x}_{1} , ⋯ , {x}_{v + {o}_{1}} ) + {δ}_{1} , \\ ⋮ \\ {ℱ}^{( {o}_{1} )} ( {x}_{1} , ⋯ , {x}_{v + {o}_{1}} ) = {ℱ}_{v}^{( {o}_{1} )} ( {x}_{i} , ⋯ , {x}_{v} ) + {ℱ}_{OV}^{( {o}_{1} )} ( {x}_{1} , ⋯ , {x}_{v + {o}_{1}} ) + {δ}_{{o}_{1}}\end{matrix} \qquad [ Equation 14 ]$$

Here, [symbol] _{V}⁽ⁱ⁾ is defined as shown in Equation 2 and [symbol] _{OV}⁽ⁱ⁾ is defined as shown in Equation 4. At this time, when O is replaced with O₁ (o₁=2k, here, k₁ is a natural number) as in 1-2 described above, Equation 3 becomes Equation 15, Equation 6 becomes Equation 16, and Equations 8 and 9 become Equation 17.

$$( \begin{matrix}{ℱ}_{V}^{( 1 )} \\ {ℱ}_{V}^{( 2 )} \\ ⋮ \\ {F}_{V}^{( {o}_{1} )}\end{matrix} ) = ( \begin{matrix}{x}_{1} & {x}_{2} & ⋯ & {x}_{v} \\ {x}_{} & {x}_{1} & ⋯ & {x}_{v - 1} \\ ⋯ & ⋯ & ⋯ & ⋯ \\ {x}_{- {o}_{1} + 2} & {x}_{- {o}_{1} + 3} & ⋯ & {x}_{- {o}_{1} + 1}\end{matrix} ) \cdot ( \begin{matrix}{L}_{1} \\ {L}_{2} \\ ⋯ \\ {L}_{}\end{matrix} ) + {M}_{v}^{1} \cdot ( \begin{matrix}{L}_{1} \\ {L}_{2} \\ ⋯ \\ {L}_{}\end{matrix} ) \qquad [ Equation 15 ]$$

Here, M_{V}¹ is a circulant matrix or a submatrix of a circulant matrix, and [symbol] _{OV}⁽ⁱ⁾ for i=1, . . . , o₁ is as shown in Equation 16.

$$( \begin{matrix}{ℱ}_{OV}^{( 1 )} \\ {ℱ}_{OV}^{( 2 )} \\ ⋮ \\ {F}_{OV}^{( {o}_{1} )}\end{matrix} ) = ( \begin{matrix}{v}^{T} {a}_{11} & {v}^{T} {a}_{12} & ⋯ & {v}^{T} {a}_{1 {o}_{1}} \\ {v}^{T} {a}_{21} & {v}^{T} {a}_{22} & ⋯ & {v}^{T} {a}_{2 {o}_{1}} \\ ⋮ & ⋮ & ⋱ & ⋮ \\ {v}^{T} {a}_{{o}_{1} 1} & {v}^{T} {a}_{{o}_{1} 2} & ⋯ & {v}^{T} {a}_{{o}_{1} {o}_{1}}\end{matrix} ) ( \begin{matrix}{x}_{v + 1} \\ {x}_{v + 2} \\ ⋮ \\ {x}_{v + {o}_{1}}\end{matrix} ) + {B}_{1} ( \begin{matrix}{x}_{v + 1} \\ {x}_{v + 2} \\ ⋮ \\ {x}_{v + {o}_{1}}\end{matrix} ) = ( \begin{matrix}{v}^{T} & 0 & ⋯ & 0 \\ 0 & {v}^{T} & ⋯ & 0 \\ ⋮ & ⋮ & ⋱ & ⋮ \\ 0 & 0 & ⋯ & {v}^{T}\end{matrix} ) ( \begin{matrix}{a}_{11} & {a}_{12} & ⋯ & {a}_{1 {o}_{1}} \\ {a}_{21} & {a}_{22} & ⋯ & {a}_{2 {o}_{1}} \\ ⋮ & ⋮ & ⋱ & ⋮ \\ {a}_{o 1} & {a}_{o 2} & ⋯ & {{a}_{{o}_{1} o}}_{1}\end{matrix} ) ( \begin{matrix}{x}_{v + 1} \\ {x}_{v + 2} \\ ⋮ \\ {x}_{v + {o}_{1}}\end{matrix} ) + {B}_{1} ( \begin{matrix}{x}_{v + 1} \\ {x}_{v + 2} \\ ⋮ \\ {x}_{v + {o}_{1}}\end{matrix} ) \qquad [ Equation 16 ]$$

### Here,

v^{T}=[χ₁χ₂ . . . χ_{υ}],

$${M}_{OV , 1} = ( \begin{matrix}{a}_{11} & {a}_{12} & ⋯ & {a}_{} \\ {a}_{21} & {a}_{22} & ⋯ & {a}_{} \\ ⋮ & ⋮ & ⋱ & ⋮ \\ {a}_{{o}_{1} 1} & {a}_{{o}_{1} 2} & ⋯ & {a}_{}\end{matrix} ) , and$$

$${B}_{1} = ( \begin{matrix}{b}_{11} & {b}_{12} & ⋯ & {b}_{} \\ {b}_{21} & {b}_{22} & ⋯ & {b}_{} \\ ⋮ & ⋮ & ⋱ & ⋮ \\ {b}_{{o}_{1} 1} & {b}_{{o}_{1} 2} & ⋯ & {b}_{}\end{matrix} ) .$$

Here, M_{OV,1} is a block circulant matrix whose elements are column vectors aᵢⱼ each having a size υ, and B₁ is a block circulant matrix.

The block circulant matrix M_{OV,1} of the vectors and the block circulant matrix B₁ are as shown in Equation 17.

$${M}_{{OV}_{1}} = ( \begin{matrix}{a}_{11} & {a}_{12} & ⋯ & {a}_{1 {o}_{1}} \\ {a}_{21} & {a}_{22} & ⋯ & {a}_{2 {o}_{1}} \\ ⋮ & ⋮ & ⋱ & ⋮ \\ {a}_{{o}_{1} 1} & {a}_{{o}_{1} 2} & ⋯ & {a}_{}\end{matrix} ) = ( \begin{matrix}{p}_{1} & {p}_{2} & ⋯ & {p}_{k} & {q}_{1} & {q}_{2} & ⋯ & {q}_{{k}_{1}} \\ {p}_{{k}_{1}} & {p}_{1} & ⋯ & {p}_{{k}_{1} - 1} & {q}_{{k}_{1}} & {q}_{1} & ⋯ & {q}_{{k}_{1} - 1} \\ ⋮ & ⋮ & ⋱ & ⋮ & ⋮ & ⋮ & ⋱ & ⋮ \\ {p}_{2} & {p}_{3} & ⋯ & {p}_{1} & {q}_{2} & {q}_{3} & ⋯ & {q}_{1} \\ {r}_{1} & {r}_{2} & ⋯ & {r}_{{k}_{1}} & {s}_{1} & {s}_{2} & ⋯ & {s}_{{k}_{1}} \\ {r}_{{k}_{1}} & {r}_{1} & ⋯ & {r}_{{k}_{1} - 1} & {s}_{{k}_{1}} & {s}_{1} & ⋯ & {s}_{{k}_{1} - 1} \\ ⋮ & ⋮ & ⋱ & ⋮ & ⋮ & ⋮ & ⋱ & ⋮ \\ {r}_{2} & {r}_{3} & ⋯ & {r}_{1} & {s}_{2} & {s}_{3} & ⋯ & {s}_{1}\end{matrix} ) = ( \begin{matrix}{P}_{1} & {Q}_{1} \\ {R}_{1} & {S}_{1}\end{matrix} ) \\ {B}_{1} = ( \begin{matrix}{b}_{11} & {b}_{12} & ⋯ & {b}_{} \\ {b}_{21} & {b}_{22} & ⋯ & {b}_{{( )}_{1}} \\ ⋮ & ⋮ & ⋱ & ⋮ \\ {b}_{{o}_{1} 1} & {b}_{{o}_{1} 2} & ⋯ & {b}_{{o}_{1} {o}_{1}}\end{matrix} ) = ( \begin{matrix}{t}_{1} & {t}_{2} & ⋯ & {t}_{{k}_{1}} & {u}_{1} & {u}_{2} & ⋯ & {u}_{{k}_{1}} \\ {t}_{{k}_{1}} & {t}_{1} & ⋯ & {t}_{{k}_{1} - 1} & {u}_{{k}_{1}} & {u}_{1} & ⋯ & {u}_{{k}_{1} - 1} \\ ⋮ & ⋮ & ⋱ & ⋮ & ⋮ & ⋮ & ⋱ & ⋮ \\ {t}_{2} & {t}_{3} & ⋯ & {t}_{1} & {u}_{2} & {u}_{3} & ⋯ & {u}_{1} \\ {v}_{1} & {v}_{2} & ⋯ & {v}_{{k}_{1}} & {w}_{1} & {w}_{2} & ⋯ & {w}_{{k}_{1}} \\ {v}_{{k}_{1}} & {v}_{1} & ⋯ & {v}_{{k}_{1} - 1} & {w}_{{k}_{1}} & {w}_{1} & ⋯ & {w}_{{k}_{1} - 1} \\ ⋮ & ⋮ & ⋱ & ⋮ & ⋮ & ⋮ & ⋱ & ⋮ \\ {v}_{2} & {v}_{3} & ⋯ & {v}_{1} & {w}_{2} & {w}_{3} & ⋯ & {w}_{1}\end{matrix} ) \qquad [ Equation 17 ]$$

Here, P₁, Q₁, R₁, S₁ are circulant matrices of vectors, and M_{OV,1} is a block circulant matrix of vectors.

At last, a constant term δᵢ is randomly selected in the finite field [symbol] _{q}. [symbol] ⁽ⁱ⁾ for i=o₁+1, . . . , m will be defined as shown in Equation 18.

$$[ Equation 18 ]$$

$$\{ \begin{matrix}{ℱ}^{( {o}_{i} + 1 )} ( {x}_{1} , ⋯ , {x}_{n} ) = {ℱ}_{V}^{( {o}_{i} + 1 )} ( {x}_{i} , ⋯ , {x}_{v + {o}_{1}} ) + {ℱ}_{OV}^{( {o}_{i} + 1 )} ( {x}_{1} , ⋯ , {x}_{n} ) + {δ}_{01} + 1 , \\ ⋮ \\ {ℱ}^{( m )} ( {x}_{1} , ⋯ , {x}_{n} ) = {ℱ}_{V}^{( {o}_{i} + {o}_{2} )} ( {x}_{i} , ⋯ , {x}_{v + {o}_{1}} ) + {ℱ}_{OV}^{( m )} ( {x}_{1} , ⋯ , {x}_{n} ) + {δ}_{m} ,\end{matrix}$$

Here, [symbol] _{V}⁽ⁱ⁾ is defined as shown in Equation 2. At this time, if Lᵢ of 1-1 described above is replaced with L′ᵢ and υ is replaced with υ+o₁, [symbol] _{V}⁽ⁱ⁾ is as shown in Equation 19.

$${ℱ}_{V}^{\text{?}} = {x}_{1} \cdot {L}_{1}^{′} + {α}_{2} {L}_{2}^{′} + ⋯ + {x}_{\text{?}} {L}_{v + 01}^{′} , \\ {ℱ}_{V}^{\text{?}} = {x}_{\text{?}} \cdot {L}_{1}^{′} + {\text{?}}_{1} {L}_{2}^{′} + ⋯ + {x}_{v + {o}_{1 - 1}} {L}_{\text{?} + 01}^{′} , \\ ⋯ , \\ {ℱ}_{V}^{\text{?}} = {x}_{v + \text{?} + 2} \cdot {L}_{1}^{′} + {x}_{\text{?} + {o}_{1} - {o}_{2} + 3} {L}_{2}^{′} + ⋯ + {x}_{v + {o}_{1} - {o}_{2} + 1} {L}_{v + 01}^{′} , \\ \text{?} \text{indicates text missing or illegible when filed} \qquad [ Equation 19 ]$$

[symbol] _{OV}⁽ⁱ⁾ is defined as shown in Equation 4. At this time, if υ described in 1-2 is replaced with υ+o₁ and O is replaced with O₂ (o₂=2k₂, here, k₂ is a natural number), Equation 3 becomes Equation 20, Equation 6 becomes Equation 21, and Equations 8 and 9 become Equation 22.

$$\begin{matrix} & [ Equation 20 ] \\ ( \begin{matrix}\text{?} \\ \text{?} \\ ⋯ \\ \text{?}\end{matrix} ) = ( \begin{matrix}{x}_{1} & {x}_{2} & ⋯ & \text{?} \\ \text{?} & {x}_{1} & ⋯ & \text{?} \\ ⋯ & ⋯ & ⋯ & ⋯ \\ \text{?} & \text{?} & ⋯ & \text{?}\end{matrix} ) \cdot ( \begin{matrix}{L}_{1}^{′} \\ {L}_{2}^{′} \\ ⋯ \\ \text{?}\end{matrix} ) = {M}_{V}^{2} \cdot ( \begin{matrix}{L}_{1}^{′} \\ {L}_{2}^{′} \\ ⋯ \\ \text{?}\end{matrix} ) \\ \text{?} \text{indicates text missing or illegible when filed} & \end{matrix}$$

Here, M_{V}² is a circulant matrix or a submatrix of a circulant matrix, and [symbol] _{OV}⁽ⁱ⁾ for i=o₁+1, . . . , o₁+o₂ will be defined as shown in Equation 21.

$$( \begin{matrix}{ℱ}_{OV}^{( {o}_{1} + 1 )} \\ {ℱ}_{OV}^{( {o}_{1} + 2 )} \\ ⋮ \\ {ℱ}_{OV}^{( {o}_{1} + {o}_{2} )}\end{matrix} ) = ( \begin{matrix}{v}^{′ T} {{a}^{′}}_{11} & {v}^{′ T} {{a}^{′}}_{12} & ⋯ & \text{?} \\ {v}^{′ T} {{a}^{′}}_{21} & {v}^{′ T} {{a}^{′}}_{22} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + {B}_{2} ( \begin{matrix}\text{?} \\ \text{?} \\ ⋮ \\ \text{?}\end{matrix} ) = ( \begin{matrix}{v}^{′ T} & 0 & ⋯ & 0 \\ 0 & {v}^{′ T} & ⋯ & 0 \\ ⋮ & ⋮ & ⋱ & ⋮ \\ 0 & 0 & ⋯ & {v}^{′ T}\end{matrix} ) ( \begin{matrix}{a}_{11}^{′} & {a}_{12}^{′} & ⋯ & \text{?} \\ {a}_{21}^{′} & {a}_{22}^{′} & ⋯ & \text{?} \\ ⋮ & ⋮ & ⋱ & ⋮ \\ \text{?} & {a}_{11}^{′} & ⋯ & \text{?}\end{matrix} ) ( \begin{matrix}\text{?} \\ \text{?} \\ ⋮ \\ \text{?}\end{matrix} ) + {B}_{2} ( \begin{matrix}\text{?} \\ \text{?} \\ ⋮ \\ \text{?}\end{matrix} ) \\ \text{?} \text{indicates text missing or illegible when filed} \qquad [ Equation 21 ]$$

### Here,

$${v}^{′ T} = [ \begin{matrix}{x}_{1} & {x}_{2} & ⋯ & \text{?} ] ,\end{matrix} \\ {M}_{OV , 2} = ( \begin{matrix}{a}_{11}^{′} & {a}_{21}^{′} & ⋯ & \text{?} \\ {a}_{21}^{′} & {a}_{22}^{′} & ⋯ & \text{?} \\ ⋮ & ⋮ & ⋱ & ⋮ \\ \text{?} & \text{?} & ⋯ & \text{?}\end{matrix} ) , and {B}_{2} = ( \begin{matrix}{b}_{11}^{′} & {b}_{21}^{′} & ⋯ & \text{?} \\ {b}_{21}^{′} & {b}_{22}^{′} & ⋯ & \text{?} \\ ⋮ & ⋮ & ⋱ & ⋮ \\ \text{?} & \text{?} & ⋯ & \text{?}\end{matrix} ) . \\ \text{?} \text{indicates text missing or illegible when filed}$$

Here, M_{OV,2} is a block circulant matrix whose elements are column vectors a′ᵢⱼ each having a size υ, and B₂ is a block circulant matrix.

The block circulant matrix M_{OV,2} of vectors and the block circulant matrix B₂ are as shown in Equation 22.

$${M}_{OV , 2} = ( \begin{matrix}{a}_{11}^{′} & {a}_{21}^{′} & ⋯ & \text{?} \\ {a}_{21}^{′} & {a}_{22}^{′} & ⋯ & \text{?} \\ ⋮ & ⋮ & ⋱ & ⋮ \\ \text{?} & \text{?} & ⋯ & \text{?}\end{matrix} ) = ( \begin{matrix}{p}_{1}^{′} & {p}_{2}^{′} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?}\end{matrix} ) = ( \begin{matrix}{P}_{2} & {Q}_{2} \\ {R}_{2} & {S}_{2}\end{matrix} ) \\ {B}_{2} = ( \begin{matrix}{b}_{11}^{′} & {b}_{21}^{′} & ⋯ & \text{?} \\ {b}_{21}^{′} & {b}_{22}^{′} & ⋯ & \text{?} \\ ⋮ & ⋮ & ⋱ & ⋮ \\ \text{?} & \text{?} & ⋯ & \text{?}\end{matrix} ) = ( \begin{matrix}{t}_{1}^{′} & {t}_{2}^{′} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?}\end{matrix} ) \\ \text{?} \text{indicates text missing or illegible when filed} \qquad [ Equation 22 ]$$

Here, p′ᵢ, q′ᵢ, s′ᵢ, r′ᵢ are column vectors each having the size υ, each of P₂, Q₂, R₂, S₂ is a circulant matrix of vectors, and M_{OV,2} is a block circulant matrix of vectors.

At last, a constant term δᵢ is randomly selected in the finite field [symbol] _{q}.
3. A public key [symbol] =S∘ [symbol] ∘T is calculated (S230).

### Signature Generation Algorithm

The signature generator 220 performs steps (S240 to S260) to perform the signature generation algorithm, that is, how to invert a new central map according to the present invention. The signature generator 220 receives the affine maps \tilde{S} and \tilde{T}, the secret central map [symbol] , and the message M.
1. A hash message H(M) for the message M is calculated (S240).

Here, H:{0, 1}*→ [symbol] _{q}^{m} is a collision resistant hash function.
2. \tilde{S}(H(M))=ξ=(ξ₁, . . . , ξₘ)∈ [symbol] _{q}^{m} is calculated (S240). If a random matrix R, that is, a circulant matrix, is given (or provided), as described in 3-2, \tilde{S}(H(M)) is calculated according to Equation 10.
3. When ξ=(ξ₁, . . . , ξₘ) is given, processes of finding [symbol] ⁻¹(ξ)=s, that is, solutions s=(s₁, . . . , sₙ) of [symbol] (x)=ξ, are as below (S250).

In a first layer,

a random vector s_{V}=(s₁, . . . , s_{υ})∈ [symbol] _{q}^{υ} is randomly selected.

The vector (sᵥ) is plugged into the first layer [symbol] _{V}⁽ⁱ⁾ for i=1, . . . , o₁ to calculate a product of a o₁×υ submatrix of a υ×υ circulant matrix and the transpose of a vector (L₁(s_{υ}), . . . , L_{υ}(s_{υ})), and, as a result, (c₁, . . . , cₒ_{₁}) is obtained. At this time, the o₁×υ submatrix into which the vector sᵥ is plugged is M_{V}¹.

The vector sᵥ is plugged into [symbol] _{OV}⁽ⁱ⁾ for i=1, . . . , o₁ to obtain a system of linear equations of O₁ equations having O₁ variables. At this time, a coefficient matrix of the system of linear equations is a block circulant matrix BC₁.

Here, the block circulant matrix BC₁ is a matrix obtained by multiplying a matrix that is obtained by plugging the vector sᵥ into a matrix composed of v^{T} in Equation 13 by M_{OV,1}.

A solution s_{υ+1}, . . . , s_{υ+o}_{₁} is obtained by multiplying the transpose of (ξ₁−c₁−δ₁, . . . , ξₒ_{₁}−cₒ_{₁}−δₒ_{₁}) by the inverse matrix BC₁⁻¹ obtained by the method defined in 2-2 described above.

In a second layer,

a vector s_{υ+o}_{₁}=(s₁, . . . , s_{υ+o}_{₁}) is plugged into the second layer [symbol] _{V}⁽ⁱ⁾ for i=o₁+1, . . . , m to calculate a product of a o₂×(υ+o₁) submatrix of a (υ+o₁)×(υ+o₁) circulant matrix and a transpose of a vector (L′₁(s_{υ+o}_{₁}), . . . , L′_{υ+o}_{₁}(s_{υ+o}_{₁})), and, as a result (cₒ_{₁}₁, . . . , cₘ), is obtained.

At this time, the o₂×(υ+o₁) submatrix into which the vector (s_{υ+o}_{₁}) is plugged is M_{V}².

The vector (s_{υ+o}_{₁}) is plugged into [symbol] _{OV}⁽ⁱ⁾ for i=o₁+1, . . . , m to obtain a system of linear equations of o₂ equations having o₂ variables. At this time, a coefficient matrix of the system of linear equations is a block circulant matrix BC₂.

Here, the block circulant matrix BC₂ is a matrix obtained by multiplying a matrix that is obtained by plugging the vector S_{υ+o}_{₁} into a matrix composed of v^{T} in Equation 21 by M_{OV,2}.

A solution (s_{υ+o}_{₁}₊₁, . . . , s_{υ+m}) is obtained by multiplying the transpose of (ξₒ_{₁}₊₁−cₒ_{₁}₊₁−δₒ_{₁}₊₁, . . . , ξₘ−cₘ−δₘ) by the inverse matrix BC₂⁻¹ obtained by the method defined in 2-2 described above. Then, a vector s=(s₁, . . . , sₙ) is a solution of [symbol] (x)=ξ.

If there is no inverse matrix BC₁⁻¹ of the block circulant matrix BC₁ or there is no inverse matrix BC₂⁻¹ of the block circulant matrix BC₂, the procedure returns to a beginning of the electronic signature algorithm to select a vector sᵥ′=(s′₁, . . . , s′_{υ}) of new random values, and performs the methods (or processes) described above again.
4. \tilde{T}(s)=σ is calculated (S260). σ refers to a signature of the message M (here, the signature is a digital signature or an electronic signature).

### Signature Verification or Verification Step:

If the signature verifier 230 receives the message M, the signature σ, and the public key [symbol] , that is, if the public key [symbol] and the signature σ for the message M are given, the signature verifier 230 checks whether P(σ)=H(M) (S270). If P(σ)=H(M), the signature σ is accepted, and otherwise, the signature σ is rejected.

A method, an apparatus (or a device), or a computer program for performing an electronic signature algorithm based on multivariate quadratic polynomials according to the embodiment of the present invention can greatly reduce a length of a secret key by using structured matrices, and generate signatures quickly by increasing calculation efficiency.

Although the present invention has been described with reference to the embodiment shown in the drawings, this is merely exemplary, and it will be understood by those skilled in the art that various modifications and equivalent other embodiments thereof can be made. Therefore, a true technical protection scope of the present invention will be defined by a technical spirit of the appended claims.

What is claimed is:

1. A method of generating a public key and a secret key using a key generator comprising:
acquiring an affine map \tilde{T} and a map ( [symbol] : [symbol] [symbol] ⁿ→ [symbol] _{q}^{m}); and
generating a public key ( [symbol] = [symbol] ∘T) and a secret key ( [symbol] , \tilde{T}) and a secret key using the affine map and the map,
wherein the map ( [symbol] : [symbol] [symbol] ⁿ→ [symbol] _{q}^{m}) is expressed as a system ( [symbol] _{V}⁽¹⁾, . . . , [symbol] _{V}^{(o)}) of O multivariate quadratic polynomials,
the system ( [symbol] _{V}⁽¹⁾, . . . , [symbol] _{V}^{(o)}) of O multivariate quadratic polynomials is expressed as below when υ linear polynomials (L₁, . . . , L_{υ}) and υ variables (χ₁, . . . , χ_{υ}) defined on a finite field [symbol] _{q} are given,
$$( \begin{matrix}{ℱ}_{V}^{( 1 )} \\ {ℱ}_{V}^{( 2 )} \\ ⋯ \\ \text{?}\end{matrix} ) = ( \begin{matrix}{x}_{1} & {x}_{2} & ⋯ & \text{?} \\ ⋯ & ⋯ & ⋯ & ⋯ \\ ⋯ & ⋯ & ⋯ & ⋯ \\ ⋯ & ⋯ & ⋯ & ⋯\end{matrix} ) \cdot ( \begin{matrix}{L}_{1} \\ {L}_{2} \\ ⋯ \\ \text{?}\end{matrix} ) = {M}_{V} \cdot ( \begin{matrix}{L}_{1} \\ {L}_{2} \\ ⋯ \\ \text{?}\end{matrix} ) , \\ \text{?} \text{indicates text missing or illegible when filed}$$
wherein, T: [symbol] _{q}ⁿ→ [symbol] _{q}ⁿ, \tilde{T}=T⁻¹, M_{V} is a structured matrix or a submatrix of a structured matrix,
m=o,
V={1, . . . , υ},
O={υ+1, . . . , υ+o},

|V|=υ, |O|=o, V is an index set for defining Vinegar variables, and O is an index set for defining Oil variables.

2. The method of claim 1,
wherein, when the system ( [symbol] _{V}⁽¹⁾, . . . , [symbol] _{V}^{(o)}) of O multivariate quadratic polynomials is expressed as below
$$( \begin{matrix}{ℱ}_{V}^{( 1 )} \\ {ℱ}_{V}^{( 2 )} \\ ⋯ \\ \text{?}\end{matrix} ) = ( \begin{matrix}{x}_{1} & {x}_{2} & ⋯ & \text{?} \\ ⋯ & ⋯ & ⋯ & ⋯ \\ ⋯ & ⋯ & ⋯ & ⋯ \\ ⋯ & ⋯ & ⋯ & ⋯\end{matrix} ) \cdot ( \begin{matrix}{L}_{1} \\ {L}_{2} \\ ⋯ \\ \text{?}\end{matrix} ) = {M}_{V} \cdot ( \begin{matrix}{L}_{1} \\ {L}_{2} \\ ⋯ \\ \text{?}\end{matrix} ) , \\ \text{?} \text{indicates text missing or illegible when filed}$$
M_{V} herein is a circulant matrix or a submatrix of a circulant matrix.

3. A computer program which is stored in a storage medium to perform the method of generating a public key and a secret key of claim 1.

4. An electronic signer comprising the key generator configured to perform the method of generating a public key and a secret key of claim 1,
wherein the electronic signer further comprises:
a signature generator configured to generate an electronic signature σ of a message M using the affine map \tilde{T}, the map [symbol] , and the message M; and
a signature verifier configured to verify the electronic signature σ using the message M, the electronic signature σ, and the public key ( [symbol] = [symbol] ∘T),
wherein the signature generator configured to calculate a hash message (H(M)=ξ) for the message M, and calculate a solution (s=(s₁, . . . , sₙ)) of [symbol] (x)=ξ using [symbol] ⁻¹(ξ)=s when ξ=(ξ₁, . . . , ξₘ) is given, and calculates \tilde{T}(s)=σ,
signature verifier determines whether P(σ)=H(M) and verify the electronic signature σ according to a result of the determination,
H:{0,1}*→ [symbol] _{q}^{m},
and
H(M)=ξ=(ξ₁, . . . , ξₘ)∈ [symbol] _{q}^{m}.

5. A method of generating a public key and a secret key using a key generator comprising:
acquiring an affine map \tilde{T} and a map ( [symbol] : [symbol] [symbol] ⁿ→ [symbol] _{q}^{m}); and
generating a public key ( [symbol] = [symbol] ∘T) and a secret key ( [symbol] , \tilde{T}) using the affine map and the map,
wherein the map ( [symbol] : [symbol] [symbol] ⁿ→ [symbol] _{q}^{m}) is expressed as a system ( [symbol] _{OV}⁽¹⁾, . . . , [symbol] _{OV}^{(o)}) of O multivariate quadratic polynomials,
the system ( [symbol] _{OV}⁽¹⁾, . . . , [symbol] _{OV}^{(o)}) of O multivariate quadratic polynomials is expressed as below when υ variables (χ₁, . . . , χ_{υ}) and O variables (χ_{υ+1}, χ_{υ+2}, . . . , χ_{υ+o}) defined on a finite field ( [symbol] _{q}) are given
$$( \begin{matrix}{ℱ}_{OV}^{( {o}_{1} + 1 )} \\ {ℱ}_{OV}^{( {o}_{1} + 2 )} \\ ⋮ \\ {ℱ}_{OV}^{( {o}_{1} + {o}_{2} )}\end{matrix} ) = ( \begin{matrix}{v}^{T} {a}_{11} & {v}^{ T} {a}_{12} & ⋯ & \text{?} \\ {v}^{T} {a}_{21} & {v}^{ T} {a}_{22} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + B ( \begin{matrix}\text{?} \\ \text{?} \\ ⋮ \\ \text{?}\end{matrix} ) = ( \begin{matrix}{v}^{ T} & 0 & ⋯ & 0 \\ 0 & {v}^{T} & ⋯ & 0 \\ ⋮ & ⋮ & ⋱ & ⋮ \\ 0 & 0 & ⋯ & {v}^{T}\end{matrix} ) ( \begin{matrix}{a}_{11} & {a}_{12} & ⋯ & \text{?} \\ {a}_{21} & {a}_{22} & ⋯ & \text{?} \\ ⋮ & ⋮ & ⋱ & ⋮ \\ \text{?} & {a}_{11} & ⋯ & \text{?}\end{matrix} ) ( \begin{matrix}\text{?} \\ \text{?} \\ ⋮ \\ \text{?}\end{matrix} ) + B ( \begin{matrix}\text{?} \\ \text{?} \\ ⋮ \\ \text{?}\end{matrix} ) , \\ \text{?} \text{indicates text missing or illegible when filed} \qquad [ Equation 21 ]$$
wherein,
$$B = ( \begin{matrix}{b}_{11} & {b}_{12} & ⋯ & \text{?} \\ {b}_{21} & {b}_{22} & ⋯ & \text{?} \\ ⋮ & ⋮ & ⋱ & ⋮ \\ \text{?} & \text{?} & ⋯ & \text{?}\end{matrix} ) , {M}_{OV} = ( \begin{matrix}{a}_{11} & {a}_{12} & ⋯ & \text{?} \\ {a}_{21} & {a}_{22} & ⋯ & \text{?} \\ ⋮ & ⋮ & ⋱ & ⋮ \\ \text{?} & \text{?} & ⋯ & \text{?}\end{matrix} ) , \\ {v}^{T} = [ \begin{matrix}{x}_{1} & {x}_{2} & ⋯ & {x}_{v} ] ,\end{matrix} \\ \text{?} \text{indicates text missing or illegible when filed}$$
T: [symbol] _{q}ⁿ→ [symbol] _{q}ⁿ, \tilde{T}=T⁻¹, and, when each column vector aᵢⱼ is regarded as an element of one matrix, each column vector aᵢⱼ is selected such that M_{OV} is a structured matrix and element values of bᵢⱼ are selected such that B is also a structured matrix of the same form as M_{OV}.

6. The method of claim 5,
when o(=2k) is an even number,
M_{OV} is a block circulant matrix of vectors when M_{OV} is expressed as below,
$${M}_{OV} = ( \begin{matrix}{a}_{11} & {a}_{21} & ⋯ & \text{?} \\ {a}_{21} & {a}_{22} & ⋯ & \text{?} \\ ⋮ & ⋮ & ⋱ & ⋮ \\ \text{?} & \text{?} & ⋯ & \text{?}\end{matrix} ) = ( \begin{matrix}{p}_{1} & {p}_{2} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?}\end{matrix} ) = ( \begin{matrix}P & Q \\ R & S\end{matrix} )$$
$$\text{?} \text{indicates text missing or illegible when filed}$$
each of pᵢ, qᵢ, sᵢ, rᵢ is a column vector having a size υ,
each of P, Q, R, S is a circulant matrix of vectors, and
B is a block circulant matrix when B is expressed as below
$$B = ( \begin{matrix}{b}_{11} & {b}_{12} & ⋯ & \text{?} \\ {b}_{21} & {b}_{22} & ⋯ & \text{?} \\ ⋮ & ⋮ & ⋱ & ⋮ \\ \text{?} & \text{?} & ⋯ & \text{?}\end{matrix} ) = ( \begin{matrix}{t}_{1} & {t}_{2} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?}\end{matrix} ) . \\ \text{?} \text{indicates text missing or illegible when filed}$$

7. A computer program that is stored in a storage medium for performing the method of generating a public key and a secret key of claim 5.

8. An electronic signer, comprising the key generator configured to perform the method of generating a public key and a secret key of claim 5,
wherein the electronic signer further comprises:
a signature generator configured to generate an electronic signature σ of a message M using the affine map \tilde{T}, the map [symbol] , and the message M; and
a signature verifier configured to verify the electronic signature σ using the message M, the electronic signature σ, and the public key ( [symbol] = [symbol] ∘T),
wherein the signature generator configured to calculate a hash message H(M)=ξ for the message M, calculate a solution (s=(s₁, . . . , sₙ) of [symbol] (x)=ξ using [symbol] ⁻¹(ξ)=s when ξ=(ξ₁, . . . , ξₘ) is given, and calculates \tilde{T}(s)=σ,
the signature verifier determines whether P(σ)=H(M) and verify the electronic signature σ according to a result of the determination,
H:{0,1}*→ [symbol] _{q}^{m},
and
H(M)=ξ=(ξ₁, . . . , ξₘ)∈ [symbol] _{q}^{m}.

9. A method of generating a public key and a secret key using a key generator comprising:
acquiring a first affine map \tilde{S}, a second affine map \tilde{T}, and a map ( [symbol] : [symbol] [symbol] ⁿ→ [symbol] _{q}^{m}); and
generating a public key [symbol] =S∘ [symbol] ∘T and a secret key (\tilde{S}, [symbol] , \tilde{T}) using the first affine map, the second affine map, and the map,
wherein, the map ( [symbol] : [symbol] [symbol] ⁿ→ [symbol] _{q}^{m}) is expressed as a system ( [symbol] = [symbol] [symbol] , . . . , [symbol] ^{(m)}) of multivariate quadratic polynomials having m=o₁+o₂ polynomials and n=υ+m variables, [symbol]
⁽ⁱ⁾ for i=1, . . . , o₁ is expressed as below,
$$\{ \begin{matrix}\text{?} ( \text{?} , … , \text{?} ) = \text{?} ( {x}_{1} , … , \text{?} ) + \text{?} ( {x}_{1} , … , \text{?} ) + \text{?} , \\ \text{?} ( \text{?} , … , \text{?} ) = \text{?} ( {x}_{1} , … , \text{?} ) + \text{?} ( {x}_{1} , … , \text{?} ) + \text{?}\end{matrix} \\ \text{?} \text{indicates text missing or illegible when filed}$$ [symbol]
_{V}⁽ⁱ⁾ for i=1, . . . , o₁ is expressed as below when υ linear equations (L₁, . . . , L_{υ}) and υ variables (χ₁, . . . , χ_{υ}) defined on a finite field [symbol] _{q} are given
$$( \begin{matrix}{ℱ}_{V}^{( 1 )} \\ {ℱ}_{V}^{( 2 )} \\ ⋮ \\ \text{?}\end{matrix} ) = ( \begin{matrix}{x}_{1} & {x}_{2} & ⋯ & \text{?} \\ ⋯ & ⋯ & ⋯ & ⋯ \\ ⋯ & ⋯ & ⋯ & ⋯ \\ ⋯ & ⋯ & ⋯ & ⋯\end{matrix} ) \cdot ( \begin{matrix}{L}_{1} \\ {L}_{2} \\ ⋯ \\ \text{?}\end{matrix} ) = {M}_{V} \cdot ( \begin{matrix}{L}_{1} \\ {L}_{2} \\ ⋯ \\ \text{?}\end{matrix} ) , \\ \text{?} \text{indicates text missing or illegible when filed}$$
wherein, M_{V}¹ is a structured matrix or a submatrix of a structured matrix, [symbol] ⁽ⁱ⁾ for i=o₁+1, . . . , m is expressed as below,
$$\{ \begin{matrix}\text{?} ( \text{?} , … , \text{?} ) = \text{?} ( {x}_{1} , … , \text{?} ) + \text{?} ( {x}_{1} , … , \text{?} ) + \text{?} \\ \text{?} ( \text{?} , … , \text{?} ) = \text{?} ( {x}_{1} , … , \text{?} ) + \text{?} ( {x}_{1} , … , \text{?} ) + \text{?}\end{matrix} , \\ \text{?} \text{indicates text missing or illegible when filed}$$ [symbol]
_{V}⁽ⁱ⁾ for i=o₁+1, . . . , m is expressed as below when linear equations (L′₁, . . . , L′_{υ+o}_{₁}) with υ+o₁ variables and υ+o₁ variables and ‘ ’ variables are given
$$( \begin{matrix}\text{?} \\ \text{?} \\ ⋮ \\ \text{?}\end{matrix} ) = ( \begin{matrix}{x}_{1} & {x}_{2} & ⋯ & \text{?} \\ ⋯ & ⋯ & ⋯ & ⋯ \\ ⋯ & ⋯ & ⋯ & ⋯ \\ ⋯ & ⋯ & ⋯ & ⋯\end{matrix} ) \cdot ( \begin{matrix}{L}_{1}^{′} \\ {L}_{2}^{′} \\ ⋯ \\ \text{?}\end{matrix} ) = {M}_{V}^{2} \cdot ( \begin{matrix}{L}_{1}^{′} \\ {L}_{2}^{′} \\ ⋯ \\ \text{?}\end{matrix} ) , \\ \text{?} \text{indicates text missing or illegible when filed}$$
wherein, M_{V}² is a structured matrix or a submatrix of a structured matrix,
m=o₁+o₂,
S: [symbol] _{q}^{m}→ [symbol] _{q}^{m}, T: [symbol] _{q}ⁿ→ [symbol] _{q}ⁿ, \tilde{S}=S⁻¹, \tilde{T}=T⁻¹,
V={1, . . . , υ},
O₁={υ+1, . . . , υ+o₁},
O₂={υ+o₁+1, . . . , υ+o₁+o₂},
which |V|=υ, i=|Oᵢ|=oᵢ for 1 and 2, V is an index set for defining Vinegar variables, and O₁ and O₂ are index sets for defining Oil variables.

10. The method of claim 9,
wherein, when the map ( [symbol] : [symbol] [symbol] ⁿ→ [symbol] _{q}^{m}) is expressed as a system ( [symbol] = [symbol] [symbol] , . . . , [symbol] ^{(m)}) of multivariate quadratic polynomials having m=o₁+o₂ polynomials and n=υ+m variables, [symbol] _{V}⁽ⁱ⁾ for i=1, . . . , o₁ is expressed as below
$$( \begin{matrix}{ℱ}_{V}^{( 1 )} \\ {ℱ}_{V}^{( 2 )} \\ ⋮ \\ \text{?}\end{matrix} ) = ( \begin{matrix}{x}_{1} & {x}_{2} & ⋯ & \text{?} \\ \text{?} & {x}_{1} & ⋯ & \text{?} \\ ⋯ & ⋯ & ⋯ & ⋯ \\ \text{?} & \text{?} & ⋯ & \text{?}\end{matrix} ) \cdot ( \begin{matrix}{L}_{1} \\ {L}_{2} \\ ⋯ \\ \text{?}\end{matrix} ) = {M}_{V}^{1} \cdot ( \begin{matrix}{L}_{1} \\ {L}_{2} \\ ⋯ \\ \text{?}\end{matrix} ) , \\ \text{?} \text{indicates text missing or illegible when filed}$$
wherein, M_{V}¹ is a circulant matrix or a submatrix of a circulant matrix, [symbol]
⁽ⁱ⁾ for i=o₁+1, . . . , m is expressed as below
$$\{ \begin{matrix}\text{?} ) + \text{?} \\ \text{?}\end{matrix} , \\ \text{?} \text{indicates text missing or illegible when filed}$$ [symbol]
_{V}⁽ⁱ⁾ for i=o₁+1, . . . , m is expressed as below
$$( \begin{matrix}\text{?} \\ \text{?} \\ ⋯ \\ \text{?}\end{matrix} ) = ( \begin{matrix}\text{?} & \text{?} & ⋯ & \text{?} \\ \text{?} & \text{?} & ⋯ & \text{?} \\ ⋯ & ⋯ & ⋯ & ⋯ \\ \text{?} & \text{?} & ⋯ & \text{?}\end{matrix} ) \text{?} ( \begin{matrix}\text{?} \\ \text{?} \\ ⋯ \\ \text{?}\end{matrix} ) = {M}_{V}^{2} ( \begin{matrix}\text{?} \\ \text{?} \\ ⋯ \\ \text{?}\end{matrix} ) , \\ \text{?} \text{indicates text missing or illegible when filed}$$
wherein, M_{V}² is a circulant matrix or a submatrix of a circulant matrix.

11. A computer program that is stored in a storage medium for performing the method of generating a public key and a secret key of claim 9.

12. An electronic signer comprising the key generator configured to perform the method of generating a public key and a secret key of claim 9,
wherein the electronic signer further comprises:
a signature generator configured to generate an electronic signature σ of a message M using the first affine map (\tilde{S}), the second affine map (\tilde{T}), the map ( [symbol] ), and the message M; and
a signature verifier configured to verify the electronic signature σ using the message M, the electronic signature σ, and the public key ( [symbol] =S∘ [symbol] ∘T),
wherein the signature generator configured to calculate a hash message H(M) for the message M, calculate \tilde{S}(H(M))=ξ=(ξ₁, . . . , ξₘ)∈ [symbol] _{q}^{m}, calculate a solution (s=(s₁, . . , sₙ)) of [symbol] (x)=ξ using [symbol] ⁻¹(ξ)=s when ξ=(ξ₁, . . . , ξₘ) is given, and calculate \tilde{T}(s)=σ,
the signature verifier configured to determine whether P(σ)=H(M) and verify the electronic signature σ according to a result of the determination, and
H:{0, 1}*→ [symbol] _{q}^{m}.

13. The electronic signer of claim 12,
wherein, when a matrix R given for randomization of the first affine map \tilde{S} in a product \tilde{S}·h of a vector h of [symbol] _{q}^{m} and the first affine map \tilde{S} is a circulant matrix, the signature generator calculates \tilde{S}(H(M)) using an equation below
\tilde{S}(H(M))=(\tilde{S}+R)(H(M))−R(H(M)).

14. The electronic signer of claim 12,
wherein, when the matrix R given for the randomization of the first affine map \tilde{S} in the product \tilde{S}·h of the vector h of [symbol] _{q}^{m} and the first affine map \tilde{S} is a circulant matrix, the signature generator calculates \tilde{S}(H(M)) using an equation below
\tilde{S}(H(M))=(\tilde{S}·R⁻¹·R)(H(M)).

15. A method of generating a public key and a secret key using a key generator comprising:
acquiring a first affine map (\tilde{S}), a second affine map (\tilde{T}), and a map ( [symbol] : [symbol] [symbol] ⁿ→ [symbol] _{q}^{m}); and
generating a public key ( [symbol] =S∘ [symbol] ∘T) and a secret key (\tilde{S}, [symbol] , \tilde{T}) using the first affine map, the second affine map, and the map,
wherein the map ( [symbol] : [symbol] [symbol] ⁿ→ [symbol] _{q}^{m}) is expressed as a system ( [symbol] = [symbol] [symbol] , . . . , [symbol] ^{(m)}) of m=o₁+o₂ multivariate quadratic polynomials,
a system ( [symbol] _{OV}⁽¹⁾, . . . , [symbol] _{OV}^{(o}^{₁}⁾) of the O₁ multivariate quadratic polynomials is expressed as below when υ variables (χ₁, . . . , χ_{υ}) and O₁ variables (χ_{υ+1}, χ_{υ+2}, . . . , χ_{υ+o}_{₁}) defined on a finite field [symbol] _{q} are given
$$( \begin{matrix}{ℱ}_{OV}^{( 1 )} \\ {ℱ}_{OV}^{( 2 )} \\ ⋮ \\ \text{?}\end{matrix} ) = ( \begin{matrix}{v}^{T} {a}_{11} & {v}^{T} {a}_{12} & ⋯ & \text{?} \\ {v}^{T} {a}_{21} & {v}^{T} {a}_{22} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + {B}_{1} ( \begin{matrix}\text{?} \\ \text{?} \\ ⋮ \\ \text{?}\end{matrix} ) = ( \begin{matrix}{v}^{T} & 0 & ⋯ & 0 \\ 0 & {v}^{T} & ⋯ & 0 \\ ⋮ & ⋮ & ⋱ & ⋮ \\ 0 & 0 & ⋯ & {v}^{T}\end{matrix} ) ( \begin{matrix}{a}_{11} & {a}_{12} & ⋯ & \text{?} \\ {a}_{21} & {a}_{22} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + {B}_{1} ( \begin{matrix}\text{?} \\ \text{?} \\ ⋮ \\ \text{?}\end{matrix} ) , \\ \text{?} \text{indicates text missing or illegible when filed}$$
wherein
$${M}_{OV , 1} = ( \begin{matrix}{a}_{11} & {a}_{12} & ⋯ & \text{?} \\ {a}_{21} & {a}_{22} & ⋯ & \text{?} \\ ⋮ & ⋮ & ⋱ & ⋮ \\ \text{?} & \text{?} & ⋯ & \text{?}\end{matrix} ) and {B}_{1} ( \begin{matrix}{b}_{11} & {b}_{12} & ⋯ & \text{?} \\ {b}_{21} & {b}_{22} & ⋯ & \text{?} \\ ⋮ & ⋮ & ⋱ & ⋮ \\ \text{?} & \text{?} & ⋯ & \text{?}\end{matrix} )$$
$$\text{?} \text{indicates text missing or illegible when filed}$$
are given,
v^{T}=[χ₁χ₂ . . . χ_{υ}],
each column vector aᵢⱼ is selected such that M_{OV,1} is a structured matrix and element values of bᵢⱼ are selected such that B₁ is also a structure matrix of the same form as M_{OV,1}, when each column vector aᵢⱼ is regarded as elements of one matrix, and [symbol]
_{OV}⁽ⁱ⁾ for i=o₁+1, . . . , m is given as below,
$$( \begin{matrix}\text{?} \\ \text{?} \\ ⋮ \\ \text{?}\end{matrix} ) = ( \begin{matrix}\text{?} & \text{?} & ⋯ & \text{?} \\ \text{?} & \text{?} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + {B}_{1} ( \begin{matrix}\text{?} \\ \text{?} \\ ⋮ \\ \text{?}\end{matrix} ) = ( \begin{matrix}{v}^{T} & 0 & ⋯ & 0 \\ 0 & {v}^{T} & ⋯ & 0 \\ ⋮ & ⋮ & ⋱ & ⋮ \\ 0 & 0 & ⋯ & {v}^{T}\end{matrix} ) ( \begin{matrix}\text{?} & \text{?} & ⋯ & \text{?} \\ □ & \text{?} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + {B}_{1} ( \begin{matrix}\text{?} \\ \text{?} \\ ⋮ \\ \text{?}\end{matrix} )$$
$$\text{?} \text{indicates text missing or illegible when filed}$$
wherein,
$${M}_{OV , 2} = ( \begin{matrix}{a}_{11}^{′} & {a}_{12}^{′} & ⋯ & \text{?} \\ {a}_{21}^{′} & {a}_{22}^{′} & ⋯ & \text{?} \\ ⋮ & ⋮ & ⋱ & ⋮ \\ \text{?} & \text{?} & ⋯ & \text{?}\end{matrix} ) and {B}_{2} ( \begin{matrix}{b}_{11}^{′} & {b}_{12}^{′} & ⋯ & \text{?} \\ {b}_{21}^{′} & {b}_{22}^{′} & ⋯ & \text{?} \\ ⋮ & ⋮ & ⋱ & ⋮ \\ \text{?} & \text{?} & ⋯ & \text{?}\end{matrix} )$$
$$\text{?} \text{indicates text missing or illegible when filed}$$
are given,
v′^{T}=[χ₁χ₂ . . . χ_{υ+o}_{₁}],
each column vector a′^{ij} is selected such that M_{OV,2} is a structured matrix and element values of b′ᵢⱼ are selected such that B₂ is also a structured matrix of the same form as M_{OV,2}, when each column vector (a′ᵢⱼ) is regarded as an element of one matrix,
S: [symbol] _{q}^{m}→ [symbol] _{q}^{m}, T: [symbol] _{q}ⁿ→ [symbol] _{q}ⁿ, \tilde{S}=S⁻¹, and \tilde{T}=T⁻¹.

16. The method of claim 15,
wherein, when o₁=2k₁ and o₂=2k₂ are given, F_{OV}⁽ⁱ⁾ for i=1, . . . , o₁ is expressed as below
$$( \begin{matrix}\text{?} \\ \text{?} \\ ⋮ \\ \text{?}\end{matrix} ) = ( \begin{matrix}\text{?} & \text{?} & ⋯ & \text{?} \\ \text{?} & \text{?} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + {B}_{1} ( \begin{matrix}\text{?} \\ \text{?} \\ ⋮ \\ \text{?}\end{matrix} ) = ( \begin{matrix}{v}^{T} & 0 & ⋯ & 0 \\ 0 & {v}^{T} & ⋯ & 0 \\ ⋮ & ⋮ & ⋱ & ⋮ \\ 0 & 0 & ⋯ & {v}^{T}\end{matrix} ) ( \begin{matrix}\text{?} & \text{?} & ⋯ & \text{?} \\ {a}_{21} & \text{?} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + {B}_{1} ( \begin{matrix}\text{?} \\ \text{?} \\ ⋮ \\ \text{?}\end{matrix} )$$
$$\text{?} \text{indicates text missing or illegible when filed}$$
wherein,
$$\text{?} = ( \begin{matrix}{a}_{11} & {a}_{12} & ⋯ & \text{?} \\ {a}_{21} & {a}_{22} & ⋯ & \text{?} \\ ⋮ & ⋮ & ⋱ & ⋮ \\ \text{?} & \text{?} & ⋯ & \text{?}\end{matrix} ) = ( \begin{matrix}{p}_{1} & {p}_{2} & ⋯ & \text{?} & {q}_{1} & {q}_{2} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ {p}_{2} & {p}_{1} & ⋯ & \text{?} & \text{?} & \text{?} & ⋯ & {q}_{1} \\ \text{?} & \text{?} & ⋯ & \text{?} & \text{?} & \text{?} & ⋯ & \text{?} \\ \text{?} & \text{?} & ⋯ & \text{?} & \text{?} \text{?} & \text{?} & ⋯ & \text{?} \\ ⋮ & ⋮ & ⋱ & ⋮ & ⋮ & ⋮ & ⋱ & ⋮ \\ {r}_{2} & {r}_{3} & ⋯ & {r}_{1} & {s}_{1} & {s}_{2} & ⋯ & \text{?}\end{matrix} ) = ( \begin{matrix}\text{?} & {Q}_{1} \\ {R}_{1} & {S}_{1}\end{matrix} ) , \\ \text{?} \text{indicates text missing or illegible when filed}$$
each of pᵢ, qᵢ, sᵢ, rᵢ is a column vector having the size υ,
each of P₁, Q₁, R₁, S₁ is a circulant matrix of vectors,
M_{OV,1} is a block circulant matrix of vectors
$$\text{?} = ( \begin{matrix}{b}_{11} & {b}_{12} & ⋯ & \text{?} \\ {b}_{21} & {b}_{22} & ⋯ & \text{?} \\ ⋮ & ⋮ & ⋱ & ⋮ \\ \text{?} & \text{?} & ⋯ & \text{?}\end{matrix} ) = ( \begin{matrix}\text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & {q}_{1} \\ \text{?} & \text{?} & ⋯ & \text{?} & \text{?} & \text{?} & ⋯ & \text{?} \\ \text{?} & \text{?} & ⋯ & \text{?} & \text{?} \text{?} & \text{?} & ⋯ & \text{?} \\ ⋮ & ⋮ & ⋱ & ⋮ & ⋮ & ⋮ & ⋱ & ⋮ \\ {r}_{2} & {r}_{3} & ⋯ & \text{?} & \text{?} & \text{?} & ⋯ & \text{?}\end{matrix} ) , \\ \text{?} \text{indicates text missing or illegible when filed}$$
B₁ is block circulant matrix, [symbol]
_{OV}⁽ⁱ⁾ for i=o₁+1, . . . , m is expressed as below
$$( \begin{matrix}\text{?} \\ \text{?} \\ ⋮ \\ \text{?}\end{matrix} ) = ( \begin{matrix}\text{?} & \text{?} & ⋯ & \text{?} \\ \text{?} & \text{?} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + {B}_{2} ( \begin{matrix}\text{?} \\ \text{?} \\ ⋮ \\ \text{?}\end{matrix} ) = ( \begin{matrix}{v}^{T} & 0 & ⋯ & 0 \\ 0 & {v}^{T} & ⋯ & 0 \\ ⋮ & ⋮ & ⋱ & ⋮ \\ 0 & 0 & ⋯ & {v}^{T}\end{matrix} ) ( \begin{matrix}\text{?} & \text{?} & ⋯ & \text{?} \\ {a}_{21}^{′} & \text{?} & ⋯ & \text{?} \\ ⋮ & ⋮ & ⋱ & ⋮ \\ \text{?} & \text{?} & ⋯ & \text{?}\end{matrix} ) ( \begin{matrix}\text{?} \\ \text{?} \\ ⋮ \\ \text{?}\end{matrix} ) + {B}_{2} ( \begin{matrix}\text{?} \\ \text{?} \\ ⋮ \\ \text{?}\end{matrix} ) , \\ \text{?} \text{indicates text missing or illegible when filed}$$
wherein,
$${M}_{OV 2} = ( \begin{matrix}\text{?} & \text{?} & ⋯ & \text{?} \\ \text{?} & \text{?} & ⋯ & \text{?} \\ ⋮ & ⋮ & ⋱ & ⋮ \\ \text{?} & \text{?} & ⋯ & \text{?}\end{matrix} ) = ( \begin{matrix}\text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ \text{?} & \text{?} & ⋯ & \text{?} & \text{?} \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?}\end{matrix} ) = ( \begin{matrix}\text{?} & {Q}_{2} \\ {R}_{2} & {S}_{2}\end{matrix} ) , \\ \text{?} \text{indicates text missing or illegible when filed}$$
p′ᵢ, q′ᵢ, s′ᵢ, r′ᵢ are column vectors each having the size (υ+o₁),
each of P₂, Q₂, R₂, S₂ is a circulant matrix of vectors,
M_{OV,2} is a block circulant matrix of vectors,
$$\text{?} = ( \begin{matrix}{V}_{11} & {V}_{12} & ⋯ & \text{?} \\ {V}_{21} & {V}_{22} & ⋯ & \text{?} \\ ⋮ & ⋮ & ⋱ & ⋮ \\ \text{?} & \text{?} & ⋯ & \text{?}\end{matrix} ) = ( \begin{matrix}\text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?} \\ \text{?} & \text{?} & ⋯ & \text{?} & \text{?} & \text{?} & ⋯ & \text{?} \\ \text{?} & \text{?} & ⋯ & \text{?} & \text{?} \text{?} & \text{?} & ⋯ & \text{?} \\ ⋮ & ⋮ & ⋱ & ⋮ & ⋮ & ⋮ & ⋱ & ⋮ \\ \text{?} & \text{?} & ⋯ & \text{?} & \text{?} & \text{?} & ⋯ & \text{?}\end{matrix} ) \\ \text{?} \text{indicates text missing or illegible when filed} \qquad$$
B₂ is a block circulant matrix, and m=o₁+o₂.

17. The method of claim 16,
wherein, when υ linear equations (L₁, . . . , L_{υ}) and υ variables (χ₁, . . . , x_{υ}) defined on the finite field are given, [symbol]
_{V}⁽ⁱ⁾ for i=1, . . . , o₁ is expressed as below,
$$( \begin{matrix}{ℱ}_{V}^{( 1 )} \\ {ℱ}_{V}^{( 2 )} \\ ⋯ \\ \text{?}\end{matrix} ) = ( \begin{matrix}{x}_{1} & {x}_{2} & ⋯ & \text{?} \\ \text{?} & {x}_{1} & ⋯ & \text{?} \\ ⋯ & ⋯ & ⋯ & ⋯ \\ \text{?} & \text{?} & \text{?} & \text{?}\end{matrix} ) \cdot ( \begin{matrix}{L}_{1} \\ {L}_{2} \\ ⋯ \\ \text{?}\end{matrix} ) = \text{?} ( \begin{matrix}{L}_{1} \\ {L}_{2} \\ ⋯ \\ \text{?}\end{matrix} )$$
$$\text{?} \text{indicates text missing or illegible when filed}$$
wherein, M_{V}¹ is a circulant matrix or a submatrix of a circulant matrix, [symbol]
_{V}⁽ⁱ⁾ for i=o₁+1, . . . , m is expressed as below when linear equations (L′₁, . . . , L′_{υ+o}_{₁}) with υ+o₁ variables and υ+o₁ variables are given
$$( \begin{matrix}\text{?} \\ \text{?} \\ ⋯ \\ \text{?}\end{matrix} ) = ( \begin{matrix}{x}_{1} & {x}_{2} & ⋯ & \text{?} \\ \text{?} & {x}_{1} & ⋯ & \text{?} \\ ⋯ & ⋯ & ⋯ & ⋯ \\ \text{?} & \text{?} & \text{?} & \text{?}\end{matrix} ) \cdot ( \begin{matrix}{L}_{1}^{′} \\ {L}_{2}^{′} \\ ⋯ \\ \text{?}\end{matrix} ) = \text{?} ( \begin{matrix}{L}_{1}^{′} \\ {L}_{2}^{′} \\ ⋯ \\ \text{?}\end{matrix} ) , \\ \text{?} \text{indicates text missing or illegible when filed}$$
wherein, M_{V}² is a circulant matrix or a submatrix of a circulant matrix, [symbol]
⁽ⁱ⁾ for i=1, . . . , m is expressed as below,
$$\{ \begin{matrix}\text{?} ( {x}_{1} , … , \text{?} ) = \text{?} ( {x}_{1} , … , \text{?} ) + \text{?} ( {x}_{1} , … , \text{?} ) + \text{?} , \\ \text{?} ( {x}_{1} , … , \text{?} ) = \text{?} ( {x}_{1} , … , \text{?} ) + \text{?} ( {x}_{1} , … , \text{?} ) + \text{?} ,\end{matrix} \\ \{ \begin{matrix}\text{?} ( {x}_{1} , … , \text{?} ) = \text{?} ( {x}_{1} , … , \text{?} ) + \text{?} ( {x}_{1} , … , \text{?} ) + \text{?} , \\ \text{?} ( {x}_{1} , … , \text{?} ) = \text{?} ( {x}_{1} , … , \text{?} ) + \text{?} ( {x}_{1} , … , \text{?} ) + \text{?} ,\end{matrix} \\ \text{?} \text{indicates text missing or illegible when filed}$$
and m=o₁+o₂.

18. A computer program that is stored in a storage medium for performing the method of generating a public key and a secret key of claim 15.

19. An electronic signer comprising the key generator configured to perform the method of generating a public key and a secret key of claim 15,
wherein the electronic signer further comprises:
a signature generator configured to generate an electronic signature σ of a message M using the first affine map (\tilde{S}), the second affine map (\tilde{T}), the map ( [symbol] ), and the message M; and
a signature verifier configured to verify the electronic signature σ using the message M, the electronic signature σ, and the public key ( [symbol] =S∘ [symbol] ∘T),
wherein the signature generator configured to calculate a hash message H(M) for the message M, calculate \tilde{S}(H(M))=ξ=(ξ₁, . . . , ξₘ)∈ [symbol] _{q}^{m}, calculate a solution (s=(s₁, . . . , sₙ)) of [symbol] (x)=ξ using [symbol] ⁻¹(ξ)=s when ξ=(ξ₁, . . . , ξₘ) is given, and calculate \tilde{T}(s)=σ,
the signature verifier configured to determine whether P(σ)=H(M), and verify the electronic signature σ according to a result of the determination, and
H:{0, 1}*→ [symbol] _{q}^{m}.

20. The electronic signer of claim 19,
wherein, when a matrix R given for randomization of the first affine map \tilde{S} in a product \tilde{S}·h of a vector h of [symbol] _{q}^{m} and the first affine map (\tilde{S}) is a circulant matrix, the signature generator calculates \tilde{S}(H(M)) using an equation below
\tilde{S}(H(M))=(\tilde{S}+R)(H(M))−R(H(M)).

21. The electronic signer of claim 19,
wherein, when the matrix R given for randomization of the first affine map \tilde{S} in a product \tilde{S}·h of a vector h of [symbol] _{q}^{m} and the first affine map (\tilde{S}) is a circulant matrix, the signature generator calculates \tilde{S}(H(M)) using an equation below
\tilde{S}(H(M))=(\tilde{S}·R⁻¹·R)(H(M)).
